(19) United States
(12) Patent Application Publication
(10) Pub. No.: US 2004/0046987 A1
(43) Pub. Date: Mar. 11, 2004

(54) Image processing apparatus and processing method therefor

(75) Inventor: Tsuyoshi Mima, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/609,369

(22) Filed: Jul. 1, 2003

(30) Foreign Application Priority Data
Jul. 11, 2002 (JP) 2002-203116

(51) Int. Cl. B41F 1/00; G06F 15/00

(52) U.S. Cl. 358/1.14; 358/1.15

(57) ABSTRACT

An image on a document is read by a reader section, and when the read image contains image storage information representing the location where the original image of the document is stored, the user is authenticated to see if he or she can utilize the original image of the document. If the user is authenticated, a server which stores the original image of the document is searched on the basis of the image storage information. The original image of the document is output from the server to a printer section.

### FIELD OF THE INVENTION

The present invention relates to an image processing apparatus which reads a document and outputs the data to a printing apparatus or external device, and a processing method therefor.

### BACKGROUND OF THE INVENTION

When printed matter which is output from a copying apparatus or printer and has halftone-processed image information is copied by a multifunctional system such as a copying apparatus using electrophotography or the like, granularity is conspicuous, resulting in serious image degradation. To prevent this, it is generally known as a conventional method to copy such printed matter in a mode in which the spatial filter or masking coefficient is changed, unlike a standard copying mode, so as to smooth the image and suppress visually unnatural roughness.

In transmitting the image of a document scanned by the above-mentioned multifunctional system to a device such as a host computer connected via a network, the scanned image is generally compressed, attached to E-mail, and then transmitted.

If printed matter which is copied and generated in the mode in which the spatial filter or masking coefficient is changed is repetitively copied, the image gradually degrades to a blurry image as a whole because the image is filtered to suppress roughness.

When a document is read by a read means such as a CCD and transmitted, the output image is always lower in quality than the document image.

In this manner, an image becomes lower in quality than the original document when printed matter output from a copying apparatus or printer is repetitively copied or a document is read and transmitted to an external device such as a host computer.

Monochrome printed matter obtained by outputting and generating a color document by a copying apparatus or printer can be transmitted as a color image only when a region to be output in color is designated and transmitted using, e.g., the editing function of an apparatus. Further, there is no system which can reproduce an original color document from generated monochrome printed matter.

### SUMMARY OF THE INVENTION

The present invention has been made to overcome the conventional drawbacks, and has as its object to provide an image processing apparatus capable of searching for and outputting an original image on the basis of information which is added to a document and represents the storage location of the original image of the document when reading the document and outputting the data for copying or transmission, and a processing method therefor.

It is another object of the present invention to limit by user authentication the use of a function of searching for and outputting an original image.

To achieve the above objects, according to one aspect of the present invention, there is provided an image processing apparatus which reads a document and outputs the document to a printing device or external device, comprising; read means for reading an image on the document; authentication means for authenticating whether a user can utilize an original image of the document when the image read by the read means contains image storage information representing a location where the original image of the document is stored; search means for searching an image storage device which stores the original image of the document on the basis of the image storage information when the user is authenticated by the authentication means; and output means for outputting the original image of the document formed by search by the search means to the printing device or external device.

According to another aspect of the present invention, there is provided a processing method for an image processing apparatus which reads a document and outputs the document to a printing device or external device, comprising; a read step of reading an image on the document; an authentication step of authenticating whether a user can utilize an original image of the document when the image read in the read step contains image storage information representing a location where the original image of the document is stored; a search step of searching an image storage device which stores the original image of the document on the basis of the image storage information when the user is authenticated in the authentication step; and an output step of outputting the original image of the document searched in the search step to the printing device or external device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view showing the whole arrangement of an image input/output system according to an embodiment;

FIG. 2 is a side sectional view showing a reader section 200 and printer section 300;

FIG. 3 is a block diagram showing the detailed arrangement of a control apparatus 110;

FIG. 4 is a block diagram showing the detailed arrangement of a reader image processor 222;

FIG. 5 is a block diagram showing the arrangement of an ACS (Auto Color Select) counting unit 604;

FIG. 6 is a block diagram showing the detailed arrangement of a part functioning as a scanner image processor 157;

FIG. 7 is a block diagram showing the detailed arrangement of a printer image processor 153;

FIG. 8 is a block diagram showing the detailed arrangement of a graphic processor 151;

FIG. 9 is a view for explaining transfer of an image having a unit of 32 pixels×32 lines;

FIG. 10 is a view for explaining rotation of an image of 32 pixels×32 lines;

FIG. 11 is a view showing the whole configuration of a network system according to the embodiment;

FIG. 12 is a block diagram showing the software configuration of a composite apparatus according to the embodiment;

FIG. 13 is a block diagram showing installation applications concerning delivery in the embodiment;

FIG. 14 is a view showing the detailed arrangement of an operation section 180;

FIG. 15 is a view showing a display example of an operation window (3010);

FIG. 16 is a view showing a display example of a COPY main window (3100);

FIG. 17 is a view showing a display example of a SEND main window (3200);

FIG. 18 is a view showing a display example of a SEND initial window 3201;

FIG. 19 is a view showing a display example of an Address Book subwindow (3220);

FIG. 20 is a view showing a display example of a Detail subwindow (3235);

FIG. 21 is a view showing a display example of a detailed destination window (3270);

FIG. 22 is a view showing a display example of a detailed Person class subwindow (3290);

FIG. 23 is a view showing a display example of a detailed Data Base class subwindow (3310);

FIG. 24 is a view showing a display example of a detailed Group class subwindow (3320);

FIG. 25 is a view showing a display example of an HD SETTING subwindow (3330);

FIG. 26 is a view showing a display example of a Print Out subwindow (3340);

FIG. 27 is a view showing a display example of a Scan Setting subwindow (3370);

FIG. 28 is a view showing a display example of a RETRIEVE main window (3400);

FIG. 29 is a view showing a display example of an E-mail subwindow (3430);

FIG. 30 is a view showing a display example of a Fax subwindow (3440);

FIG. 31 is a view showing a display example of an FTP Server subwindow (3450);

FIG. 32 is a view showing a display example of a TASKS main window (3500);

FIG. 33 is a flow chart showing PDL image output processing according to the embodiment;

FIG. 34 is a flow chart showing copy image output processing according to the embodiment; and

FIG. 35 is a flow chart showing scanned-image transmission processing according to the embodiment.

### DETAILED DESCRIPTION OF THE PREFERRED EMBODIMENT

A preferred embodiment of the present invention will be described in detail below with reference to the accompanying drawings.

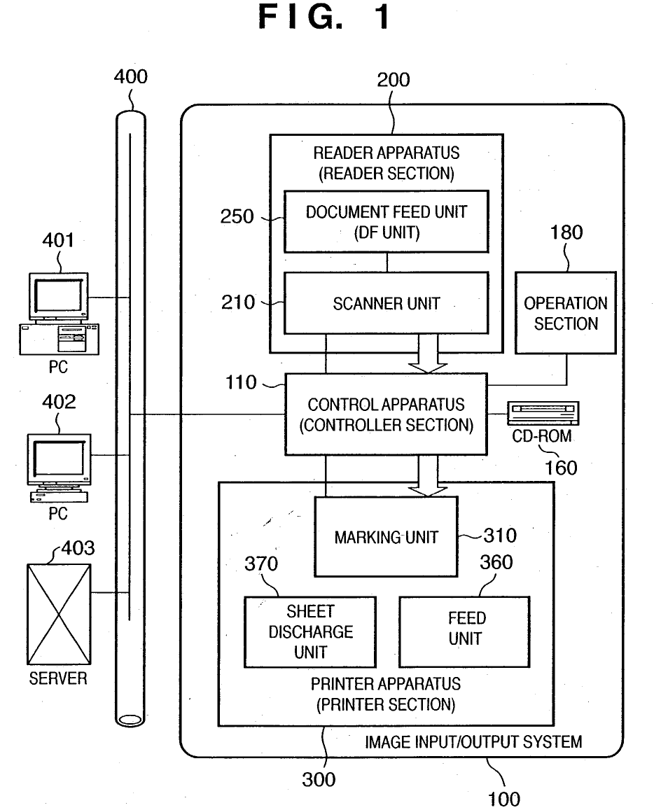

FIG. 1 is a view showing the whole arrangement of an image input/output system according to the embodiment. As shown in FIG. 1, a reader section (image input apparatus) 200 optically reads a document image, converts it into image data, and outputs the data. The reader section 200 comprises a scanner unit 210 having a function of reading a document, and a document feed unit (DF unit) 250 having a function of conveying a document sheet.

A printer section (image output apparatus) 300 conveys a print sheet, prints image data as a visible image on the print sheet, and discharges the print sheet outside the apparatus. The printer section 300 comprises a sheet feed unit 360 having a plurality of types of print sheet cassettes, a marking unit 310 having a function of transferring and fixing image data onto a print sheet, and a sheet discharge unit 370 having a function of sorting and stapling a printed print sheet and outputting it outside the apparatus.

A control apparatus 110 is electrically connected to the reader section 200 and printer section 300, and connected to host computers (PCs) 401 and 402 and a server 403 via a network 400. The control apparatus 110 provides a copying function of controlling the reader section 200 to load document image data, and controlling the printer section 300 to output image data onto a print sheet. The control apparatus 110 further provides a scanner function of converting image data read by the reader section 200 into code data, and transmitting the code data to a host computer via the network 400. The control apparatus 110 also provides a printer function of converting code data received from a host computer via the network 400 into image data, and outputting the image data to the printer section 300.

An operation section 180 is connected to the control apparatus 110, comprises a liquid crystal touch panel, and provides a user I/F for operating the image input/output system. The operation section 180 has a user authentication function of limiting for each user a function of outputting an original image from storage location information (to be described later) added to a document.

As the feature of the embodiment, the scanner unit 210 comprises a function of reading original storage location information (represented by a barcode in the embodiment) of a document image that is printed at the edge of a document, in addition to a function of optically reading a document image. An original image is created by the host computer 401 or 402, and stored in the server 403 in outputting the image by the printer section 300. The printer section 300 prints, by a barcode at the end of a print sheet, information such as an IP address for specifying the server 403 and a directory and file name in the server 403, as original storage location information. If the scanner unit 210 reads the original storage location information on the document and the operation section 180 authenticates the control apparatus 110, the control apparatus 110 searches for address information of the original image stored in the server 403, and outputs the original image by the printer section 300 from the server 403.

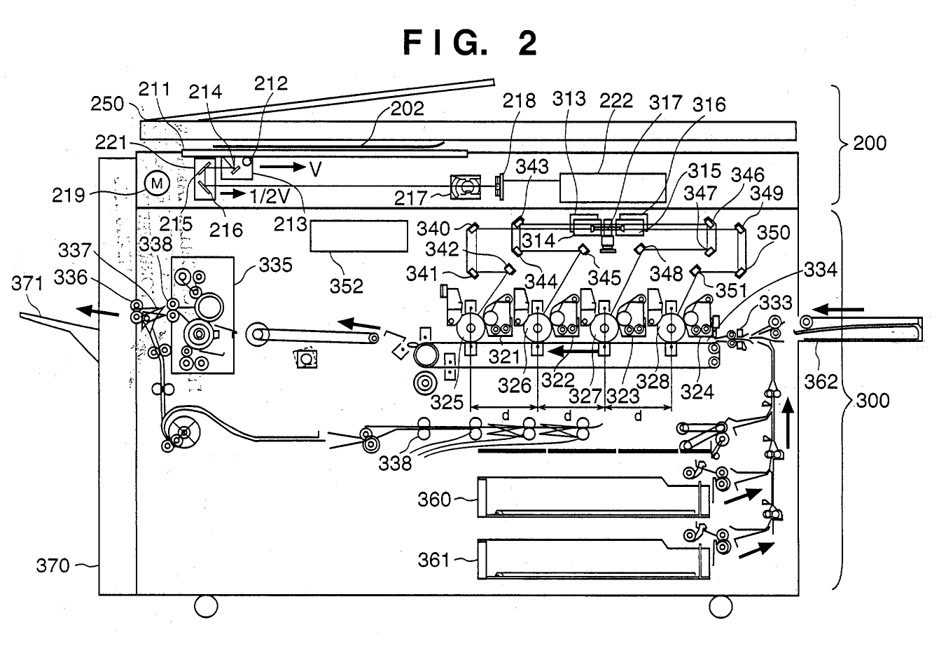

FIG. 2 is a side sectional view showing the reader section 200 and printer section 300. The document feed unit 250 of the reader section 200 feeds document sheets one by one onto a platen glass 211. At the end of document read operation, the document sheet on the platen glass 211 is discharged. When a document sheet is conveyed onto the platen glass 211, a lamp 212 is turned on, and movement of an optical unit 213 starts to expose and scan the document sheet. Light reflected by the document sheet is guided to a CCD image sensor (to be referred to as a CCD hereinafter) 218 by mirrors 214, 215, and 216 and a lens 217. The image of the scanned document sheet is read by the CCD 218.

The reader section 200 comprises a reader image processing circuit 222 which performs predetermined processing for image data output from the CCD 218 and outputs the processed data to the control apparatus 110 via a scanner I/F.

The printer section 300 comprises a printer image processing circuit 352 which outputs to a laser driver 317 an image signal sent from the control apparatus 110 via a printer I/F. The laser driver 317 drives laser-emitting portions 313, 314, 315, and 316, and causes the laser-emitting portions 313, 314, 315, and 316 to emit laser beams in accordance with image data output from the printer image processing circuit 352. The laser beams irradiate photosensitive drums 325, 326, 327, and 328 via mirrors 340, 341, 342, 343, 344, 345, 346, 347, 348, 349, 350, and 351, forming latent images corresponding to the laser beams on the photosensitive drums 325, 326, 327, and 328. Reference numerals 321, 322, 323, and 324 denote developing units for developing latent images by black (Bk), yellow (Y), cyan (C), and magenta (M) toners. The developed toners in the respective colors are transferred onto a sheet, outputting a full-color print.

A sheet fed from any one of sheet cassettes 360 and 361 and a manual feed tray 362 at a timing synchronized with the start of laser beam irradiation is chucked and conveyed on a transfer belt 334 via a registration roller 333. Developing agents attached to the photosensitive drums 325, 326, 327, and 328 are transferred onto the print sheet. The print sheet bearing the developing agents is conveyed to a fixing portion 335, and the developing agents are fixed onto the print sheet by the heat and pressure of the fixing portion, 335. The print sheet having passed through the fixing portion 335 is discharged by a discharge roller 336. A sheet discharge unit 370 bundles discharged print sheets, sorts the print sheets, staples the sorted print sheets, and sets the resultant print sheets on a tray 371.

When double-sided printing is set, a print sheet is conveyed up to the discharge roller 336, the rotational direction of the discharge roller 336 is reversed, and the print sheet is guided to a refeed convey path 338 by a flapper 337. The print sheet guided to the refeed convey path 338 is fed to the transfer belt 334 at the above-described timing.

<Description of Reader Image Processor>

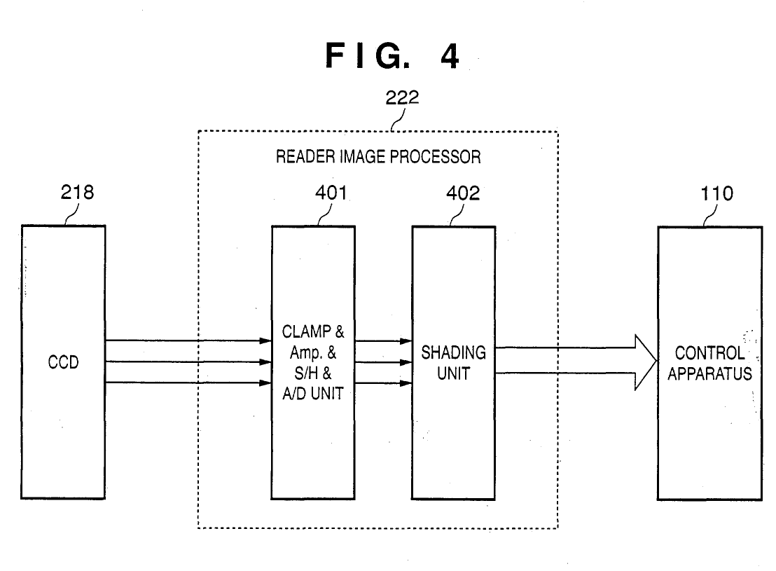

FIG. 4 is a block diagram showing the detailed arrangement of the reader image processor 222. In the reader image processor 222, a document on the platen glass 211 is read by the CCD 218, and converted into an electrical signal (when the CCD 218 is a color sensor, it may be constituted by arranging R, G, and B color filters in line on a 1-line CCD in the order of R, G, and B, arranging R, G, and B filters on the respective CCDs of a 3-line CCD, or arranging filters on a chip or separately from a CCD). The electrical signal (analog image signal) is input to the reader image processor 222, sampled and held (S/H) by a clamp & Amp. & S/H & A/D unit 401. The dark level of the analog image signal is clamped to a reference potential, amplified to a predetermined amount (the processing order does not coincide with this described order), and A/D-converted into e.g., 8-bit R, G, and B digital signals. The R, G, and B signals are subjected shading correction and black correction by a shading unit 402, and output to the control apparatus 110.

<Description of Control Apparatus>

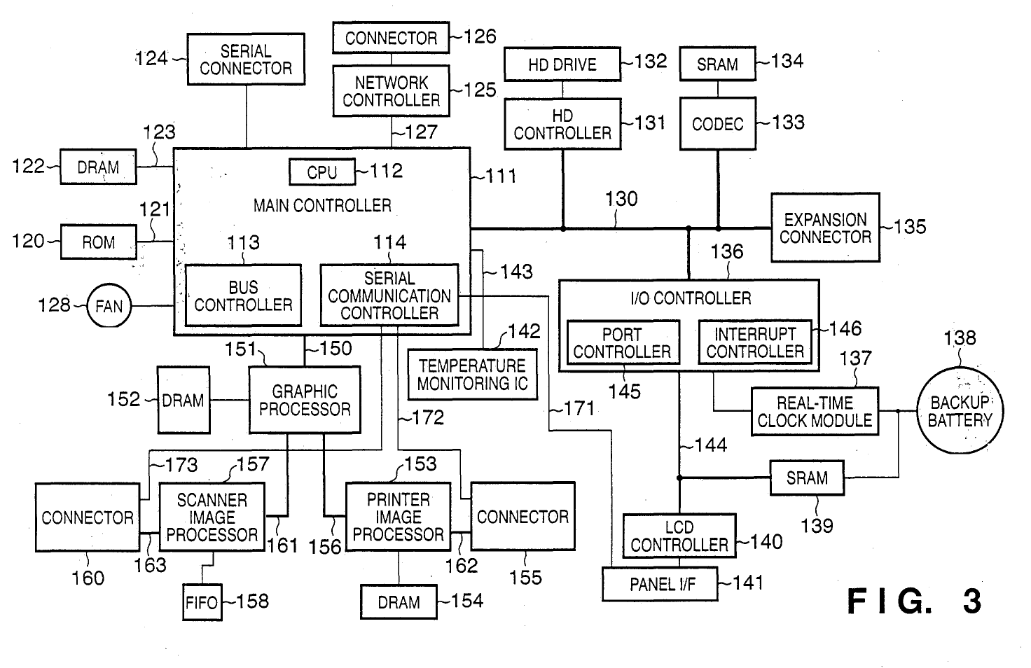

The function of the control apparatus 110 will be explained with reference to the block diagram shown in FIG. 3. As shown in FIG. 3, a main controller 111 is mainly comprised of a CPU 112, bus controller 113, and various I/F controller circuits.

The CPU 112 and bus controller 113 control the overall control apparatus 110, and the CPU 112 operates on the basis of a program loaded from a ROM 120 via a ROM I/F 121. Operation of interpreting PDL (Page Description Language) code data received from a host computer and rasterizing the data into raster image data is also described in the program and processed by software. The bus controller 113 controls transfer of data input/output to/from each I/F, arbitrates bus contention, and controls DMA data transfer.

As the feature of the embodiment, when a print request is received from a host computer, the main controller 111 controls via a network controller 125 and connector 126 to store an original image at a predetermined address in the server 403 connected to a network. If printing of original storage location information on an output sheet is permitted, the main controller 111 transmits stored address information to a printer image processor 153 via an I/F 150, graphic processor 151, and printer bus 156, and instructs the printer image processor 153 to print the address information as a barcode on an output sheet.

The main controller 111 receives user authentication information input from a panel I/F 141 via a key input I/F 171, and determines whether the user is authorized to use a function according to the embodiment.

If the user is authenticated and reads a document having original storage location information, the main controller 111 receives via a scanner bus 161, the graphic processor 151, and the I/F 150 information on the address at which the original decoded by a scanner image processor 157 is stored. The main controller 111 searches via the network controller 125 and connector 126 for the original image stored in the server 403 connected to the network. The main controller 111 extracts the original image and transmits it to the printer image processor 153 via the I/F 150, graphic processor 151, and printer bus 156.

A DRAM 122 is connected to the main controller 111 via a DRAM I/F 123, and used as a work area for operating the CPU 112 and an area for accumulating image data.

A start-stop synchronization serial communication controller 114 in the main controller 111 exchanges control commands with the CPUs of the reader section 200 and printer section 300 via serial buses 172 and 173, and performs communication of touch panel and key inputs with the operation section 180.

The network controller 125 is connected to the main controller 111 via an I/F 127 and to an external network via the connector 126. The network is generally an Ethernet®.

A serial connector 124 is connected to the main controller 111, and communicates with an external device. The serial bus is generally a USB.

A fan 128 is connected to the main controller 111, and used to cool the control apparatus 110 A temperature monitoring IC 142 is connected to the main controller 111 via a serial bus 143. The temperature monitoring IC 142 is used to control the fan 128 and correct the temperature of a real-time clock module 137.

A general-purpose high-speed bus 130 is connected to an expansion connector 135 for connecting an expansion board, an I/O controller 136, an HD (Hard Disk) controller 131, and a Codec 133. The general-purpose high-speed bus is generally a PCI bus.

The Codec 133 compresses raster image data accumulated in the DRAM 122 by a method such as MH, MR, MMR, JBIG, or JPEG, and decompresses compressed/accumulated code data into raster image data. An SRAM 134 is used as a temporary work area for the Codec 133. Data transfer between the SRAM 134 and the Codec 133 is controlled by the bus controller 113, and data is DMA-transferred.

The HD controller 131 is used to connect an external storage device, and an HD drive 132 is connected via the HD controller 131. The HD drive 132 is used to store programs and image data.

The I/O controller 136 controls a data bus 144, port controller 145, and interrupt controller 146.

The panel I/F 141 is connected to an LCD controller 140, and constituted by an I/F for display on the liquid crystal screen of the operation section 180 and the key input I/F 171 for performing a hard key input and touch panel key input.

The operation section 180 comprises a liquid crystal display, a touch panel input device adhered onto the liquid crystal display, and a plurality of hard keys. A signal input from the touch panel or hard key is transmitted to the CPU 112 via the key input I/F 171. The liquid crystal display displays image data sent from the panel I/F 141. The liquid crystal display displays a function, image data, and user authentication window in the operation of the image forming apparatus.

The real-time clock module 137 updates and saves a date and time managed within the apparatus, and is backed up by a backup battery 138.

An SRAM 139 is backed up by the backup battery 138, and accumulates a user mode, pieces of various setting information, file management information of the HD drive 132, and the like.

The graphic processor 151 performs image rotation, image zoom, color space transform, binarization, scanner image input, and printer image output for image data accumulated in the DRAM 122. A DRAM 152 is used as a temporary work area for the graphic processor 151. The graphic processor 151 is connected to the main controller 111 via the I/F 150. Data transfer between the graphic processor 151 and the DRAM 122 is controlled by the bus controller 113, and data is DMA-transferred.

Connectors 160 and 155 are respectively connected to the reader section 200 and printer section 300, and comprised of start-stop synchronization serial I/Fs (173 and 172) and video I/Fs (163 and 162).

The scanner image processor 157 is connected to the reader section 200 via the connector 160 and to the graphic processor 151 via the scanner bus 161. The scanner image processor 157 has a function of performing predetermined processing for an image received from the reader section 200, and a function of outputting to the scanner bus 161 a control signal generated on the basis of a video control signal sent from the reader section 200.

The scanner image processor 157 also has a function of extracting original storage location information added at a predetermined position in image data, decoding the information into address information, and transmitting the address information to the main controller 111 via the scanner bus 161, graphic processor 151, and I/F 150.

A FIFO 158 is connected to the scanner image processor 157, and used for line correction of a video signal sent from the reader section 200.

The printer image processor 153 is connected to the printer section 300 via the connector 155 and to the graphic processor 151 via the printer bus 156. The printer image processor 153 has a function of performing predetermined processing for image data output from the graphic processor 151 and outputting the resultant data to the printer section 300, and a function of outputting to a printer bus 162 a control signal generated on the basis of a video control signal sent from the printer section 300.

When printing of original storage location information is permitted in printing from a host computer, address information received from the main controller 111 via the I/F 150, graphic processor 151, and printer bus 156 is converted into a barcode, and an image is so formed as to add the barcode at a predetermined position on an output sheet.

A DRAM 154 is connected to the printer image processor 153, and used to delay a video signal by a predetermined time.

Transfer of raster image data rasterized in the DRAM 122 to the printer section 300 is controlled by the bus controller 113. The data is DMA-transferred to the printer section 300 via the graphic processor 151, printer image processor 153, and connector 155.

<Description of Scanner Image Processor>

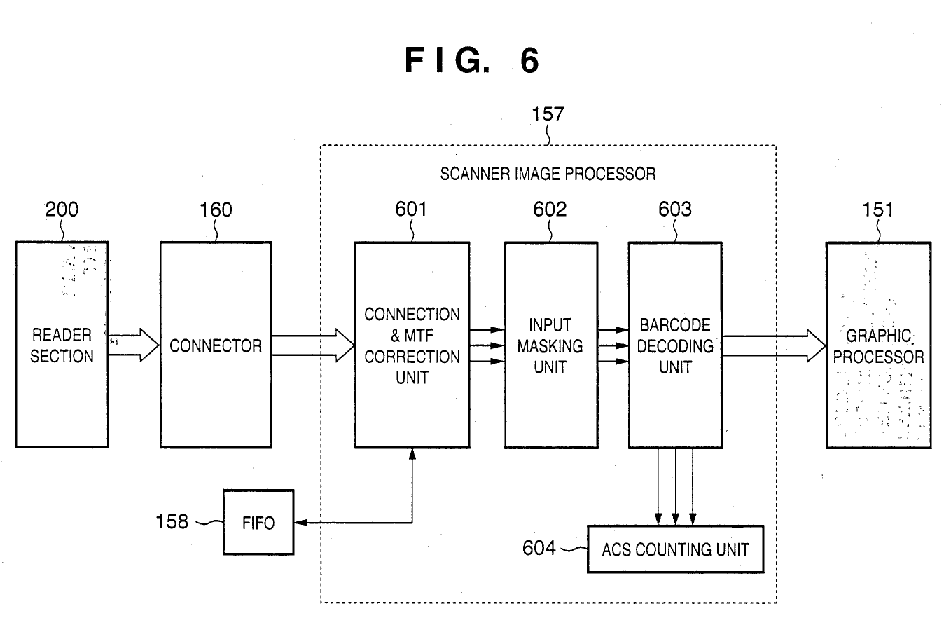

The scanner image processor 157 will be explained in detail. FIG. 6 is a block diagram showing the detailed arrangement of a part functioning as the scanner image processor 157.

A connection & MTF correction unit 601 adjusts the delay amount of each line in accordance with the read speed for an image signal sent from the reader section 200 via the connector 160, and corrects changed MTF by the read speed. When the CCD 218 is a 3-line CCD, the signal timing is corrected by connection processing so as to make the read positions of three lines coincide with each other. The FIFO 158 is used as a line delay buffer. An input masking unit 602 corrects the spectral characteristic of the CCD 218 and the spectral characteristics of the lamp 212 and mirrors 214, 215, and 216 for digital signals whose read position timings have been corrected. A barcode decoding unit 603 reads a barcode representing original storage location information printed at a predetermined position on a document, and converts the barcode into address information of the server 403 where the original is stored. An output from the barcode decoding unit 603 is sent to an ACS counting unit 604 and the graphic processor 151. The address information generated by the barcode decoding unit 603 is sent to the main controller 111 via the graphic processor 151.

<Description of ACS Counting Unit>

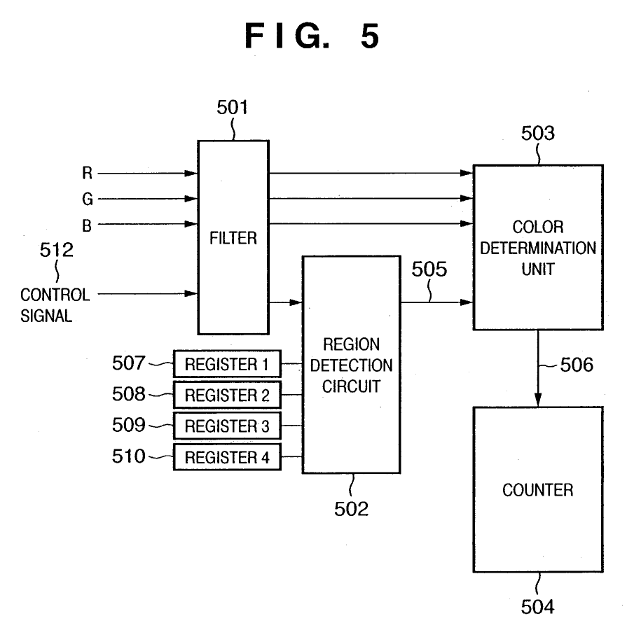

The ACS (Auto Color Select) counting unit 604 will be described with reference to FIG. 5.

In auto color select (to be referred to as ACS hereinafter), whether a document is color or monochrome is determined. That is, the color saturation of each pixel is obtained, and color determination is done on the basis of the number of pixels equal to or higher than a given threshold. Even a monochrome document microscopically contains many color pixels near the edge under the influence of MTF or the like, and it is difficult to perform ACS determination simply for each pixel. Various ACS methods are provided, but the embodiment adopts a general ACS method.

As described above, even a monochrome image microscopically contains many color pixels, and whether a pixel of interest is a color pixel must be determined from information on color pixels around the pixel of interest. In FIG. 5, reference numeral 501 denotes a filter which has a FIFO structure in order to refer to pixels around a pixel of interest; 502, a circuit which generates an ACS region signal 505 on the basis of values set in registers 507 to 510 by the main controller 111 and a video control signal 512 sent from the reader section 200; 503, a color determination unit which refers to pixels around the pixel of interest in the memory of the filter 501 on the basis of the ACS region signal 505 and determines whether the pixel of interest is a color or monochrome pixel; and 504, a counter which counts the number of color determination signals 506 output from the color determination unit 503.

The main controller 111 determines an ACS region within a loading range, and sets the region in the registers 507 to 510 (in the embodiment, the range is determined independently of a document). The main controller 111 compares with a predetermined threshold the value of the counter which counts the number of color determination signals in the ACS region, and determines whether the document is color or monochrome.

Positions at which the color determination unit 503 starts determination and positions at which determination ends are set in the registers 507 to 510 in the main scanning and subscanning directions on the basis of the video control signal 512 sent from the reader section 200. In the embodiment, these positions are set inward by about 10 mm from an actual document size.

<Description of Printer Image Processor>

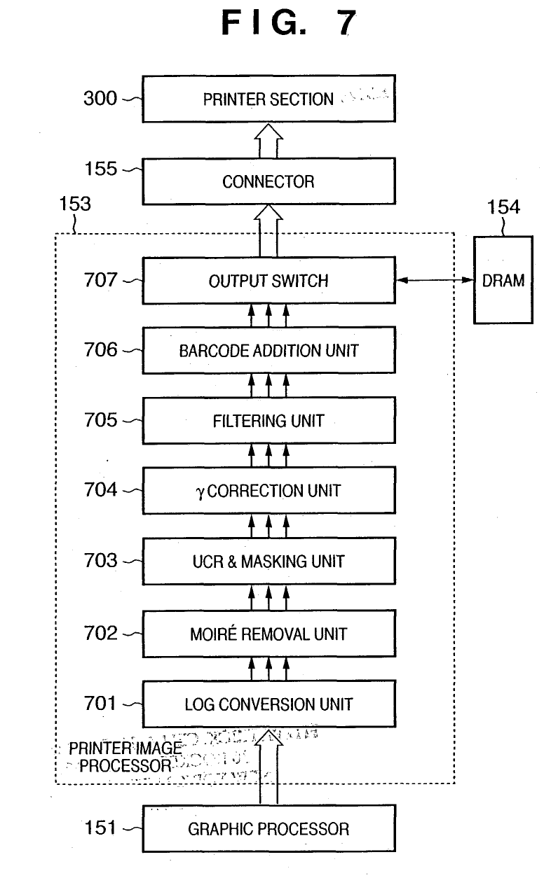

A part functioning as the printer image processor 153 will be explained in detail. FIG. 7 is a block diagram showing the detailed arrangement of the printer image processor 153.

An image signal which is sent from the graphic processor 151 via the printer bus 156 is input to a LOG conversion unit 701. The LOG conversion unit 701 LOG-converts R, G, and B signals into C, M, and Y signals. A moiré removal unit 702 removes moiré. The moiré-removed C, M, and Y signals are input to a UCR & masking unit 703, and subjected to UCR processing to generate C, M, Y, and K signals. The C, M, Y, and K signals are corrected to signals suitable for the printer by the masking processing unit. The signals processed by the UCR & masking unit 703 undergo density adjustment by a γ correction unit 704, and smoothing or edge processing by a filtering unit 705. A barcode addition unit 706 receives address information at which an original image is stored in the server 403, and a barcode printing permission signal. If barcode printing is permitted, the address information is converted into a barcode, and an image is formed at a predetermined position on a sheet. An output switch 707 temporarily accumulates respective C, M, Y, and K images in the DRAM 154 in order to correct the distances between the photosensitive drums 325 to 328, and then sends to the printer section 300 via the connector 155 the images for which the distances between the drums are corrected.

<Description of Graphic Processor>

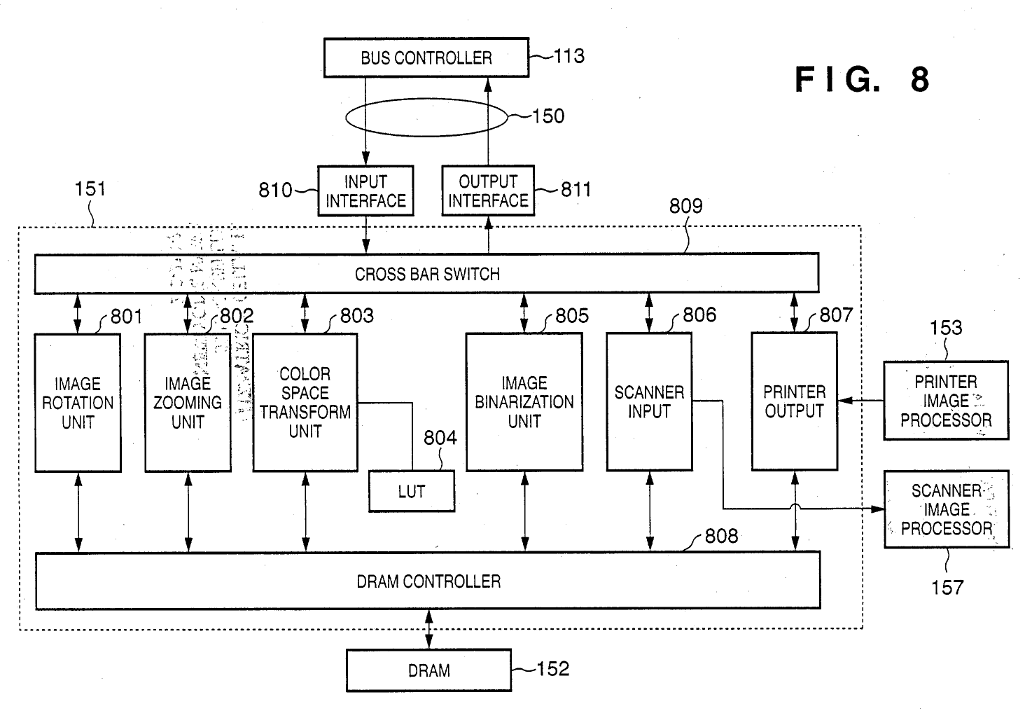

The graphic processor 151 will be described in detail. FIG. 8 is a block diagram showing the detailed arrangement of the graphic processor 151.

The graphic processor 151 has modules for performing image rotation, image zoom, color space transform, binarization, scanner image input, and printer image output. The DRAM 152 is used as a temporary work area for the modules via a DRAM controller 808. A work area is statistically assigned to each module in advance so as to prevent contention of the work areas of the DRAM 152 used by respective modules. The graphic processor 151 is connected to the main controller 111 via the I/F 150. Data transfer between the graphic processor 151 and the DRAM 122 is controlled by the bus controller 113, and data is DMA-transferred.

The bus controller 113 executes control of setting a mode or the like in each module of the graphic processor 151, and timing control of transferring image data to each module.

An input interface 810 inputs image data from the I/F 150 to a cross bar switch 809. The image data format includes binary raster image data, multilevel raster image data, and JPEG. For a JPEG image, image data is converted into raster image data by the input interface 810, and the data is output to the cross bar switch 809.

An output interface 811 outputs image data from the cross bar switch 809 to the I/F 150. The image data format input from the cross bar switch 809 is raster image data. JPEG compression may be done by the output interface 811 to output data to the I/F 150.

The processing procedures of an image rotation unit, image zooming unit, color space transform unit, binarization unit, scanner image input unit, and printer image output unit in the graphic processor 151 will be explained in detail.

<Description of Image Rotation Unit>

The processing procedures of an image rotation unit 801 will be described. Image rotation control settings are performed for the bus controller 113 by the CPU 112 via the I/F 150. Upon these settings, the bus controller 113 performs settings (image size, rotational direction, angle, and the like) necessary for image rotation in the image rotation unit 801. After necessary settings, the CPU 112 permits the bus controller 113 to transfer image data. In accordance with this permission, the bus controller 113 starts transfer of image data from the DRAM 122 or a device connected via each I/F. In this case, the rotation image size is 32 pixels×32 lines, and an image is transferred every 24 bytes (one pixel for 8-bit R, G, and B) in transferring image data onto the image bus.

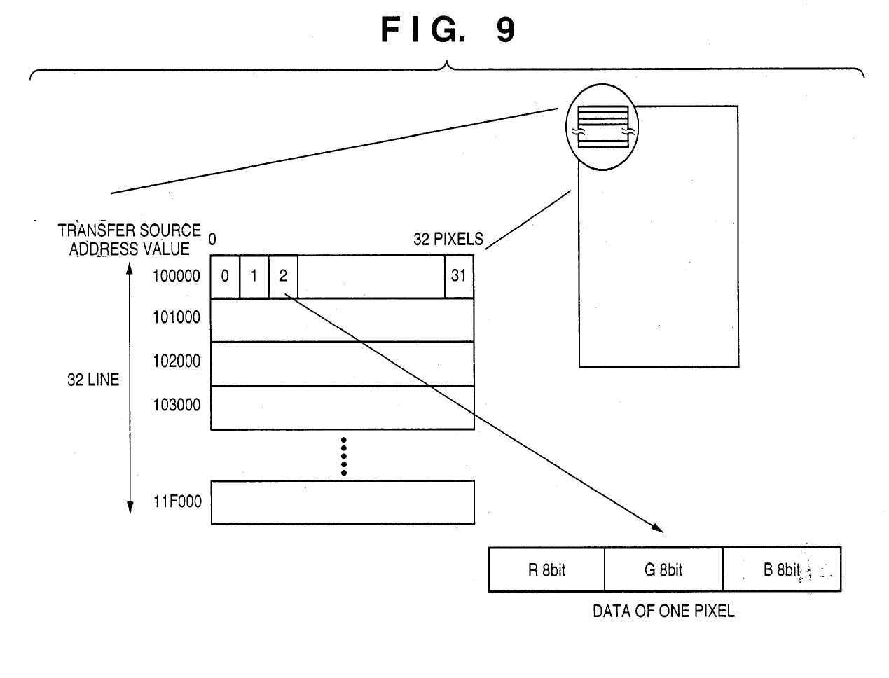

As described above, in order to obtain an image of 32 pixels×32 lines, the above-mentioned unit data transfer must be executed 32×32 times, and image data must be transferred from inconsecutive addresses (see FIG. 9).

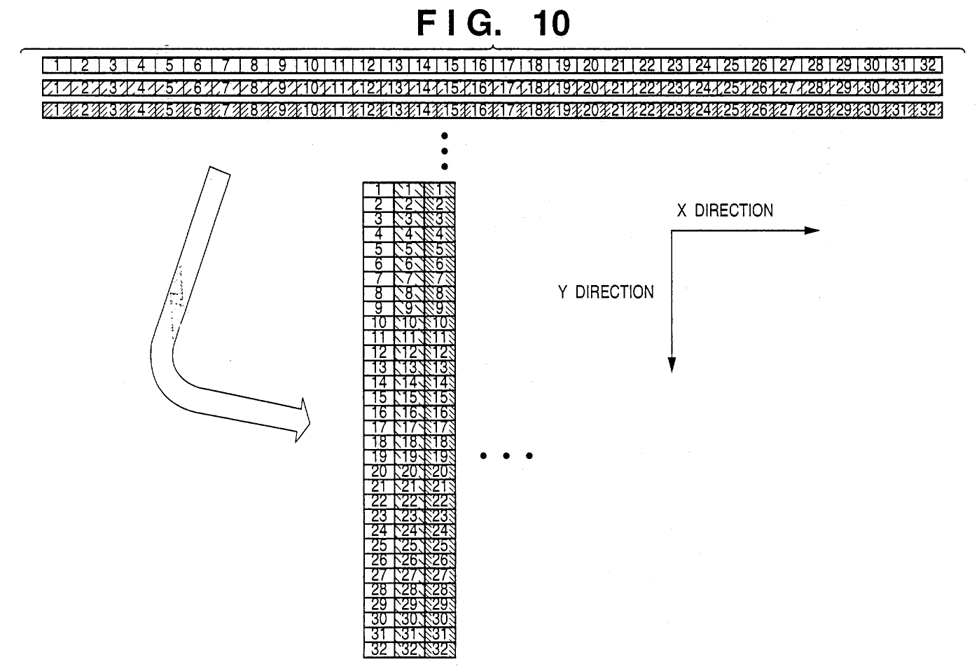

Image data transferred by inconsecutive addressing is written in the SRAM 136 as if the image was rotated at a desired angle in read. For example, for 90° counterclockwise rotation, transferred image data is written in the Y direction, and read out in the X direction in read, rotating the image, as shown in FIG. 10.

Upon the completion of rotating the image of 32 pixels×32 lines (write in the DRAM 152), the image rotation unit 801 reads out the image data from the DRAM 152 by the above read method, and transfers the image to the bus controller 113. The bus controller 113 which has received the rotated image data transfers the data to the DRAM 122 or each device on an I/F by consecutive addressing.

A series of processes are repeated until no processing request is sent from the CPU 112 (a necessary number of pages are processed).

<Description of Image Zooming Unit>

The processing procedures of an image zooming unit 802 will be described. Image zooming control settings are performed for the bus controller 113 by the CPU 112 via the I/F 150. Upon these settings, the bus controller 113 performs settings (main scanning zoom ratio, subscanning zoom ratio, image size after zoom, and the like) necessary for image zoom in the image zooming unit 802. After necessary settings, the CPU 112 permits the bus controller 113 to transfer image data. In accordance with this permission, the bus controller 113 starts transfer of image data from the DRAM 122 or a device connected via each I/F.

The image zooming unit 802 temporarily stores the received image data in the DRAM 152, and uses the DRAM 152 as an input buffer. The image zooming unit 802 achieves zoom processing by performing interpolation processing by necessary numbers of pixels and lines in accordance with the main scanning and subscanning zoom ratios for the stored data and enlarging/reducing the image. The image zooming unit 802 writes the zoomed data again in the DRAM 152, and uses the DRAM 152 as an output buffer. The image zooming unit 802 reads out the image data from the DRAM 152, and transfers the data to the bus controller 113.

The bus controller 113 which has received the zoomed image data transfers the data to the DRAM 122 or each device on an I/F.

<Description of Color Space Transform Unit>

The processing procedures of a color space transform unit 803 will be described. Color space transform control settings are performed for the bus controller 113 by the CPU 112 via the I/F 150. Upon these settings, the bus controller 113 performs settings (matrix operation coefficient to be described below, the table value of an LUT 804, and the like) necessary for color space transform processing in the color space transform unit 803 and an LUT (Look Up Table) 804. After necessary settings, the CPU 112 permits the bus controller 113 to transfer image data. In accordance with this permission, the bus controller 113 starts transfer of image data from the DRAM 122 or a device connected via each I/F.

The color space transform unit 803 executes the following 3×3 matrix operation for each pixel of the received image data.

$$[ \begin{matrix}X \\ Y \\ Z\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}R + {b}_{1} \\ G + {b}_{2} \\ B + {b}_{3}\end{matrix} ] + [ \begin{matrix}{c}_{1} \\ {c}_{2} \\ {c}_{3}\end{matrix} ] \qquad ( 1 )$$

where R, G, and B are inputs, X, Y, and Z are outputs, and a₁₁, a₁₂, a₁₃, a₂₁, a₂₂, a₂₃, a₃₁, a₃₂, a₃₃, b₁, b₂, b₃, c₁, c₂, and c₃ are coefficients.

By operation of equation (1), various color space transforms such as transform from an RGB color space into a Yuv color space can be executed.

Transform using the LUT 804 is performed for the data having undergone matrix operation. This transform can also realize nonlinear transform. By setting a through table, LUT transform may be skipped in effect. After that, the color space transform unit 803 transfers the image data having undergone color space transform processing to the bus controller 113.

The bus controller 113 which has received the image data having undergone color space transform processing transfers the data to the DRAM 122 or each device on an I/F.

<Description of Image Binarization Unit>

The processing procedures of an image binarization unit 805 will be described. Binarization control settings are performed for the bus controller 113 by the CPU 112 via the I/F 150. Upon these settings, the bus controller 113 performs settings (various parameters corresponding to the transform method, and the like) necessary for binarization processing in the image binarization unit 805. After necessary settings, the CPU 112 permits the bus controller 113 to transfer image data. In accordance with this permission, the bus controller 113 starts transfer of image data from the DRAM 122 or a device connected via each I/F.

The image binarization unit 805 performs binarization processing for the received image data. In the embodiment, as the binarization method, image data is compared with a predetermined threshold, and simply binarized. Needless to say, any method such as dithering, error diffusion, or an improvement of error diffusion can be adopted.

The image binarization unit 805 transfers the binarized image data to the bus controller 113. The bus controller 113 which has received the binarized image data transfers the data to the DRAM 122 or each device on an I/F.

<Description of Scanner Input Unit>

The processing procedures of a scanner input unit 806 will be described. Scanner input control settings are performed for the bus controller 113 by the CPU 112 via the I/F 150. Upon these settings, the bus controller 113 performs settings (various parameters corresponding to input processing, and the like) necessary for the scanner input unit 806. After necessary settings, the CPU 112 permits the bus controller 113 to transfer image data. Image data is input to the scanner input unit 806 in synchronism with a sync signal input from the scanner image processor 157. The scanner input unit 806 temporarily stores the received image data in the DRAM 152 serving as an output buffer. The scanner input unit transfers the image stored in the DRAM 152 to the bus controller 113. The bus controller 113 which has received the scanner input image data transfers the data to the DRAM 122 or each device on an I/F.

<Description of Printer Output Unit>

The processing procedures of a printer output unit 807 will be described. Printer output control settings are performed for the bus controller 113 by the CPU 112 via the I/F 150. Upon these settings, the bus controller 113 performs settings (various parameters corresponding to output processing, and the like) necessary for the printer output unit 807. After necessary settings, the CPU 112 permits the bus controller 113 to transfer image data. In accordance with this permission, the bus controller 113 starts transfer of image data from the DRAM 122 or a device connected via each I/F.

The printer output unit 807 temporarily stores the received image data in the DRAM 152. The printer output unit 807 outputs the image stored in the DRAM 152 to the printer image processor 153 in accordance with a sync signal input from the printer image processor 153.

[Software]

<Whole System>

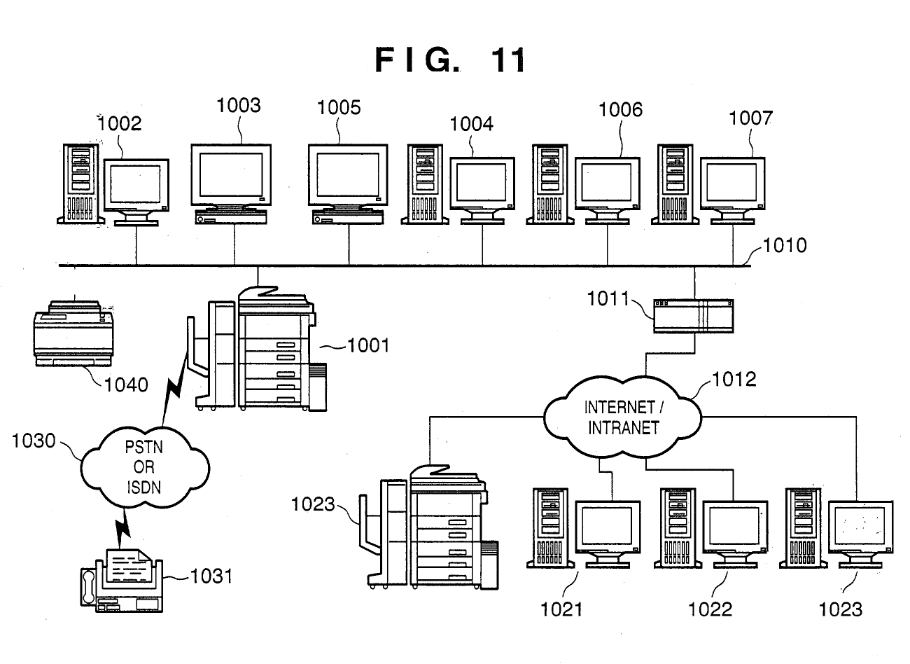

The whole configuration of a network system will be explained. FIG. 11 is a view showing the whole configuration of the network system according to the embodiment. Reference numeral 1001 denotes an apparatus according to the present invention which is constituted by a scanner and printer, can supply an image read by the scanner to a local area network 1010 (to be referred to as a LAN hereinafter), print out an image received from the LAN by the printer, transmit an image read by the scanner to a PSTN or ISDN (1030) by a FAX transmission means (not shown), and print out an image received by the PSTN or ISDN by the printer; 1002, a database server which manages in a database a binary image and multilevel image loaded from the apparatus 1001; and 1003, a database client for the database server 1002 that can browse and search for image data saved in the database server 1002.

Reference numeral 1004 denotes an E-mail server which can receive an image read by the apparatus 1001 as a file attached to E-mail; 1005, an E-mail client which can receive and browse mail received by the E-mail server 1004, and transmit E-mail; 1006, a WWW server which provides an HTML document to the LAN, and can print out by the apparatus 1001 an HTML document provided by the WWW server 1006; and 1007, a router which couples the LAN 1010 to Internet/intranet 1012. Apparatuses 1020, 1021, 1022, and 1023 identical to the database server (1002), WWW server (1006), E-mail server (1004), and apparatus (1001) are coupled to the Internet/intranet. The apparatus 1001 can communicate with a FAX apparatus 1031 via the PSTN or ISDN (1030). A printer 1040 is also coupled to the LAN, and can print out an image read by the apparatus 1001.

<Whole Configuration of Software Block>

The software configurations of the apparatuses (composite apparatuses) 1001 and 1023 according to the present invention shown in FIG. 11 will be described.

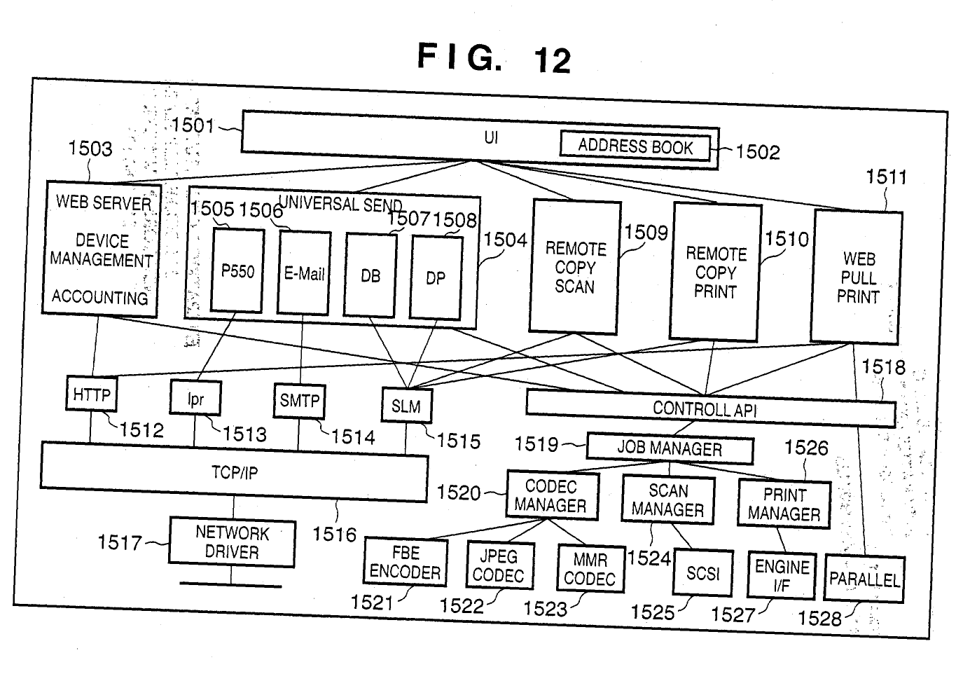

FIG. 12 is a block diagram showing the software configuration of the composite apparatus according to the embodiment. Reference numeral 1501 denotes a UI module which controls a user interface, and mediates a device when the operator performs various operations and settings of the composite apparatus. This module transfers input information to various modules (to be described later) in accordance with the operation of the operator, and performs processing request, data setting, or the like.

Reference numeral 1502 denotes an Address-Book module, i.e., database module which manages a data sending destination, communication destination, and the like. The contents of the Address-Book 1502 are obtained by adding, deleting, and acquiring data by the operation of the UI 1501, and provides data sending/communication destination information to each module (to be described later) in accordance with the operation of the operator.

Reference numeral 1503 denotes a Web-server module which is used to transmit management information of the composite apparatus in response to a request from a Web client (not shown). Management information is read via a Controll-API 1518, and transmitted to the Web client via an HTTP 1512, TCP/IP 1516, and Network-Driver 1517 (to be described later).

Reference numeral 1504 denotes a Universal-Send module which delivers data, and distributes data designated by the operator via the UI 1501 to a similarly designated communication (output) destination. When the operator designates generation of distribution data by using the scanner function of the apparatus, the apparatus is operated via the Controll-API 1518 (to be described later) to generate data.

Reference numeral 1505 denotes a module which is executed when a printer is designated as an output destination in the Universal-Send 1504; 1506, a module which is executed when an E-mail address is designated as a communication destination in the Universal-Send 1504; 1507, a module which is executed when a database is designated as an output destination in the Universal-Send 1504; and 1508, a module which is executed when a composite apparatus similar to the apparatus is designated as an output destination in the Universal-Send 1504.

Reference numeral 1509 denotes a Remove-Copy-Scan module which uses the scanner function of the composite apparatus, uses another composite apparatus connected via a network or the like as an output destination, and performs the same processing as a Copy function realized by the single composite apparatus.

Reference numeral 1510 denotes a Remote-Copy-Print module which uses the printer function of the composite apparatus, uses another composite apparatus connected via a network or the like as an input source, and performs the same processing as a Copy function implemented by the single composite apparatus.

Reference numeral 1511 denotes a Web-Pull-Print module which reads out information of various homepages on the Internet or intranet and prints the information.

Reference numeral 1512 denotes a module which is used for HTTP communication by the composite apparatus, and provides communication to the Web-server module 1503 and Web-Pull-Print module 1511 by the TCP/IP communication module 1516 (to be described later); 1513, an Ipr module which provides communication to the printer module 1505 in the Universal-Send 1504 by the TCP/IP module 1516; 1514, a SMTP module which provides communication to the E-mail module 1506 in the Universal-Send 1504 by the TCP/IP 1516; and 1515, a SLM, i.e., Salutation-Manager module which provides communication to the database module 1507, DP module 1508, Remove-Copy-Scan module 1509, and Remote-Copy-Print module 1510 in the Universal-Send 1504 by the TCP/IP 1516.

The TCP/IP communication module 1516 provides network communication to various modules described above by the Network-Driver (to be described next). The Network-Driver 1517 controls a portion physically connected to a network.

The Controll-API 1518 provides an interface with a downstream module such as a Job-Manager 1519 (to be described below) to an upstream module such as the Universal-Send 1504. The Controll-API 1518 reduces dependence between upstream and downstream modules, enhancing their applications.

The Job-Manager 1519 interprets processes designated by various modules described above via the Controll-API 1518, and supplies instructions to modules (to be described below). This module centralizes hardware processing executed in the composite apparatus.

Reference numeral 1520 denotes a CODEC-Manager which manages and controls various compression/decompression processes of data in processes designated by the Job-Manager 1519.

Reference numeral 1521 denotes an FBE-Encoder which compresses, by an FBE format, data loaded by scan processing executed by the Job-Manager 1519 and a Scan-Manager 1524; 1522, a JPEG-CODEC which performs JPEG compression processing of loaded data and JPEG decompression processing of print data in scan processing executed by the Job-Manager 1519 and Scan-Manager 1524 and print processing executed by a Print-Manager 1526; and 1523, an MMR-CODEC which performs MMR compression processing of loaded data and MMR decompression processing of print data in scan processing executed by the Job-Manager 1519 and Scan-Manager 1524 and print processing executed by the Print-Manager 1526.

The Scan-Manager 1524 manages and controls scan processing designated by the Job-Manager 1519. Reference numeral 1525 denotes a SCSI driver which communicates with a scanner section internally connected in the composite apparatus.

The Print-Manager 1526 manages and controls print processing designated by the Job-Manager 1519. Reference numeral 1527 denotes an Engine-I/F driver which provides an I/F between the Print-Manager 1526 and a printer section.

Reference numeral 1528 denotes a Parallel port driver which provides an I/F used when the Web-Pull-Print 1511 outputs data to an output device (not shown) via a parallel port.

<Application>

Installation applications according to the embodiment will be described with reference to the accompanying drawings.

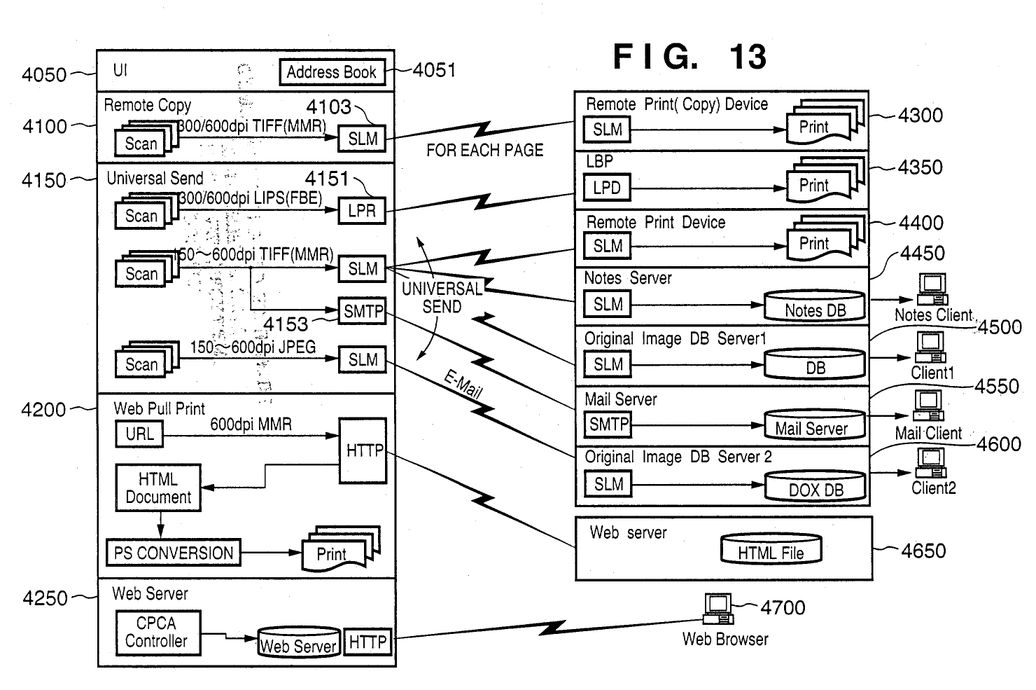

FIG. 13 is a block diagram showing installation applications concerning delivery in the embodiment. In FIG. 13, reference numeral 4050 denotes a block representing a User Interface application; 4100, a block representing a Remote Copy application transmitting side; 4150, a block representing a Universal Send side; 4200, a block representing a Web Pull Print module; and 4250, a block representing a Web Server module.

Reference numeral 4300 denotes a block representing a Remote Copy receiving side (Print side); 4350, a block which receives and prints a universally sent image by a general-purpose printer; 4400, a block representing a Remote Print receiving side (Print side); 4450, a block which receives and stores a universally sent image by a known Notes Server; 4500, a block which receives and stores a universally sent binary image; 4550, a block which receives and stores a universally sent image by a known Mail Server; 4600, a block which receives and stores a universally sent multilevel image; 4650, a block representing a known Web Server containing information contents; and 4700, a known Web Browser which accesses the Web Server according to the embodiment.

Applications will be explained in detail with reference to the respective blocks.

<User Interface Application>

The User Interface (to be referred to as a UI hereinafter) 4050 has been described in detail above, and an Address Book 4051 will be explained. The Address Book is saved in a nonvolatile storage device (nonvolatile memory, hard disk, or the like) in the apparatus according to the present invention. The Address Book describes the feature of a device connected to a network. For example, the Address Book contains the following features.

Formal name and alias name of a device

Network address of a device

Network protocol processible by a device

Document format processible by a device

Compression type processible by a device

Image resolution processible by a device

Feedable paper size for printer device, and sheet feed stage information

Folder name capable of storing document for server (computer) device

Each of the following applications can determine the feature of a delivery destination by information described in the Address Book 4051. The Address Book 4051 can be edited, and can be used by downloading or directly referring to one saved in a server computer or the like on a network.

<Remote Copy Application>

The Remote Copy application determines from the Address Book 4051 resolution information processible by a device designated as a delivery destination, and compresses a binary image read by a scanner by known MMR compression in accordance with the resolution information. The Remote Copy application converts the compressed image by known TIFF (Tagged Image File Format), and transmits the TIFF image to a printer device on a network via an SLM 4103. Although not described in detail, the SLM 4103 is a kind of network protocol containing device control information called known Salutation Manager (or Smart Link Manager).

<Universal Send Application>

The Universal Send application can transmit an image to a plurality of delivery destinations by one image scanning, unlike the Remote Copy application. The delivery destination is not limited to a printer device, and can directly deliver an image to a so-called server computer. The Universal Send application will be explained in accordance with the delivery destination.

When it is determined from the Address Book 4051 that a delivery destination device can process a known network printer protocol “LPD (Line Printer Daemon)” and a known printer control command “LIPS”, an image is read in accordance with the image resolution similarly determined from the Address Book 4051. In the embodiment, the image is compressed using known FBE (First Binary Encoding), converted into an LIPS code, and transmitted to a partner device by a known network printer protocol “LPR”.

When the delivery destination device can communicate by SLM and is a server device, designation of a server address and a folder in the server is determined from the Address Book 4051. Similar to the Remote Copy application, a binary image read by a scanner is compressed using known MMR compression, converted by known TIFF (Tagged Image File Format), and stored in a specific folder in the server device on the network via SLM.

When the server as a partner device is determined to be able to process a multilevel image compressed by known JPEG, the device according to the embodiment can convert a read multilevel image by known JFIF using known JPEG compression, and store the resultant image in a specific folder in the server device on the network via SLM, similar to the above-described binary image.

When the delivery destination device is a known E-Mail server, a mail address described in the Address Book 4051 is determined. A binary image read by a scanner is compressed using known MMR compression, converted by known TIFF (Tagged Image File Format), and transmitted to the E-Mail server by using a known SMTP (Simple Mail Transfer Protocol) 4153. The subsequent delivery is executed in accordance with the Mail Server 4550.

<Outline of Operation Section>

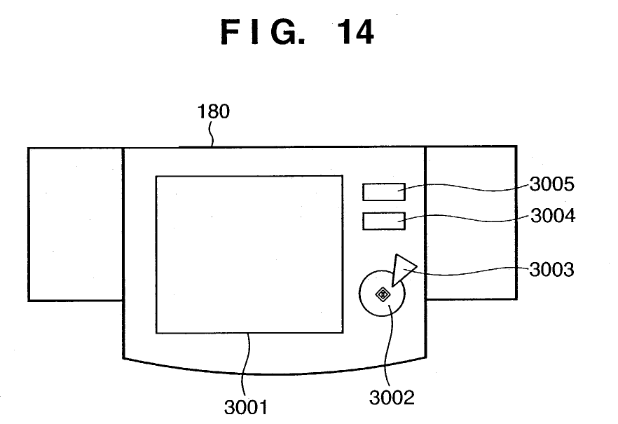

The arrangement of the operation section 180 will be described. FIG. 14 is a view showing the detailed arrangement of the operation section 180. An LCD display (3001) is constituted by adhering a touch panel sheet onto the LCD, and displays the operation window of the system. When a displayed key is touched, the LCD display transmits the position information to a controller CPU. A start key (3002) is used to start document image read operation. Two, green and red LEDs are arranged at the center of the start key, and the color exhibits whether the start key is available. A stop key (3003) is used to stop the current operation. An ID key (3004) is used to input the user ID of the user. A reset key (3005) is used to initialize settings from the operation section.

Each window in the operation section 180 will be explained in detail.

<Operation Window>

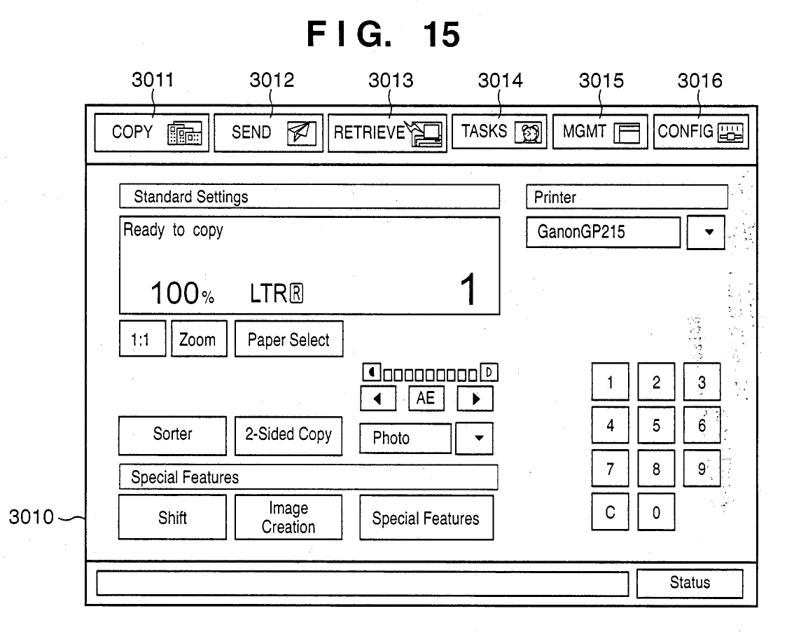

Functions provided by the composite apparatus according to the embodiment are classified into six large categories: Copy, Send, Retrieve, Tasks, Management, and Configuration. These categories correspond to six main tabs (COPY, SEND, RETRIEVE, TASKS, MGMT, and CONFIG) (3011 to 3016) displayed at an upper portion in an operation window (3010) shown in FIG. 15. These main tabs are touched to switch the window to the window of each category. When switching to another category is not permitted, the display color of the main tab is changed, and the window does not react to touch on the main tab.

Copy includes a function of performing standard document copying by using the scanner and printer of the apparatus itself, and a function (remote copy) of copying a document by using the scanner of the apparatus itself and a printer connected via a network. Send is a function of transferring a document set on the scanner of the apparatus itself to E-mail, a remote printer, a facsimile apparatus, file transfer (FTP), and a database. A plurality of destinations can be designated. Retrieve is a function of acquiring an external document and printing it by the printer of the apparatus itself. As a document acquisition means, the WWW, E-mail, file transfer, and a facsimile apparatus are available. In Tasks, a task for automatically processing a document externally transmitted from a facsimile apparatus, Internet printer, or the like and periodically executing Retrieve is generated and managed. In Management, a job, address book, bookmark, document, account information, and the like are managed. In Configuration, settings (network, timepieces, and the like) for the apparatus are executed.

A method of setting these functions will be explained using examples of the LCD window display.

<ID Input Window>

An ID input window is displayed immediately after power-on operation or when the ID key is pressed. If a user ID and password are correctly input on the ID input window and an OK button is touched, the above-mentioned operation window is displayed, allowing operation. The ID input region and password input region can be switched by directly touching the input region.

<COPY Window>

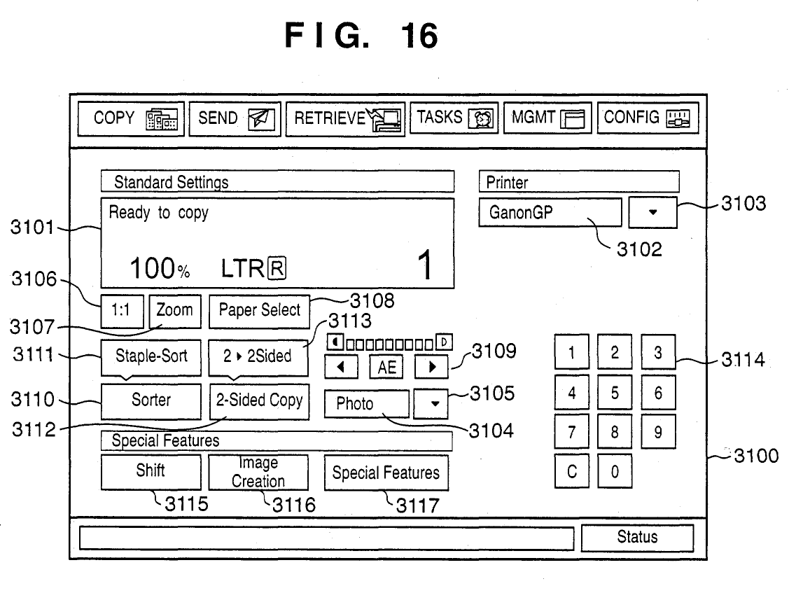

When the start button is touched upon displaying a COPY window shown in FIG. 16, the scanner operates to output a copy from a selected printer in accordance with setting parameters displayed in the window.

A COPY main window (3100) comprises a printer selection button (3103), a printer display region (3102), an Image Quality selection button (3105), an Image Quality display region (3104), a copy parameter display (3101) similar to a conventional copying apparatus, enlargement/reduction setting buttons (3106 and 3107), a paper selection button (3108), a sorter setting button (3110), a 2-sided copy setting button (3112), a density indicator & density setting button (3109), and a numeric key region (3114).

When the printer selection button (3103) is touched, a list (3120) of available printers (a printer of the apparatus itself and printers connected via a network) is displayed as a pull-down menu. If a desired printer is selected from the list, the list disappears, and the selected printer name is displayed in the printer display region (3102).

When the Image Quality setting button (3105) is touched, an Image Quality list (3125) is displayed, and a desired Image Quality can be selected from the list.

When the copy parameter setting button is touched, a subwindow (enlargement/reduction setting, paper selection, sorter setting, or 2-sided copy setting) for a corresponding setting is displayed. Parameters can be set similarly to setting in a conventional copying apparatus. The density can also be set similarly to a conventional copying apparatus.

<SEND Window>

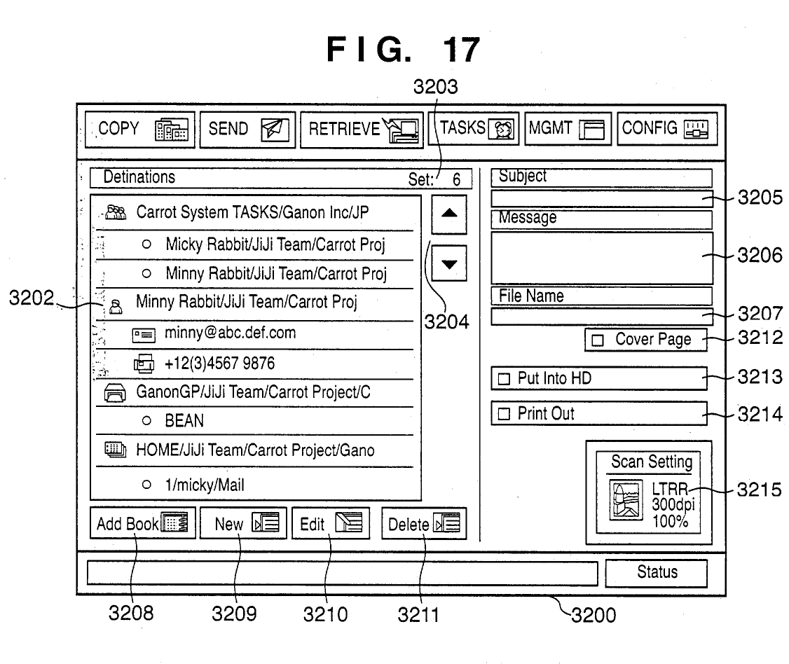

When the start button is touched upon displaying a Send window shown in FIG. 17, the scanner operates, and processing of transmitting read image data to a set destination by a designated transmission method starts.

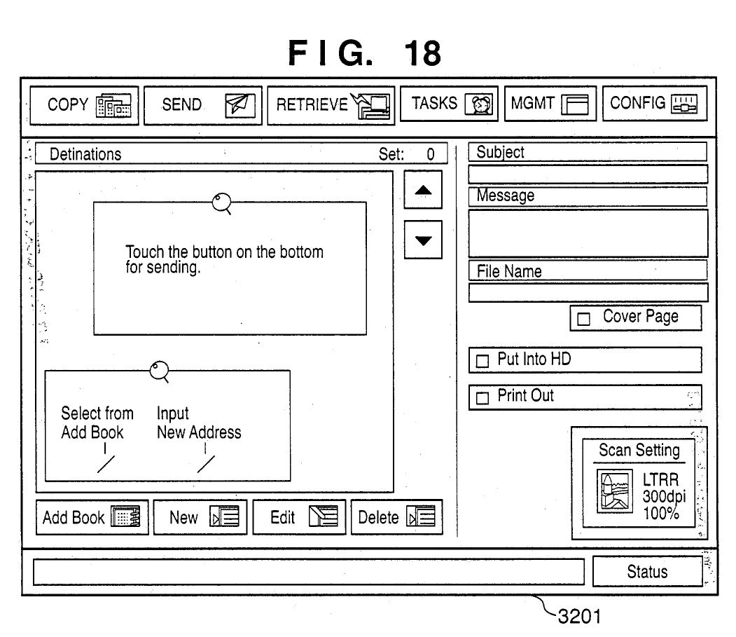

A SEND main window (3200) comprises a destination display region (3202), a detailed destination count display region (3203), a destination scroll button (3204), an Address Book button (3208), a New button (3209), an Edit button (3210), a Delete button (3211), a Subject input region (3205), a Message input region (3206), a File Name input region (3207), a Cover page check button (3212), a Put Into HD check button (3213), a Print Out check button (3214), and a Scan Setting button (3215). In initialization including reset, no destination is displayed in a destination display region 3201, and an operation instruction window is displayed, as shown in FIG. 18.

The destination display region (3202) displays a list of input destinations. Inputs are sequentially added to the last. The detailed destination count display region (3203) displays a currently set destination count. If the Delete button (3211) is touched after a given destination is selected from the destination display region (3202), the selected destination is deleted. If the Subject input region (3205), Message input region (3206), or File Name input region (3207) is touched, a full keyboard is displayed, allowing an input.

<Address Book Subwindow>

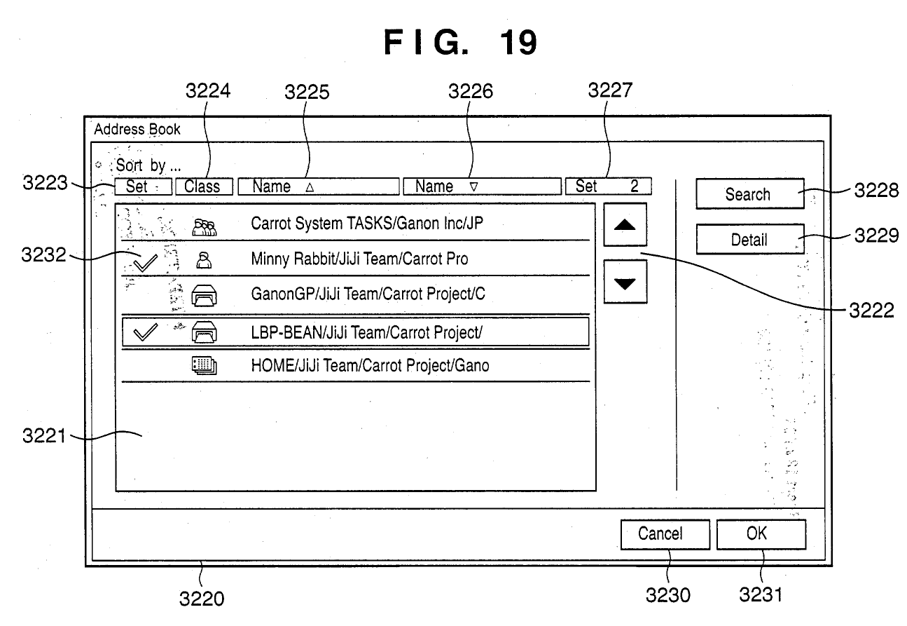

When the Address Book button (3208) is touched in the window shown in FIG. 17, an Address Book subwindow (3220) shown in FIG. 19 is displayed. A destination with a selection mark (3232) in an Address Book display region (3221) is added to the destination display region (3202) of the SEND main window shown in FIG. 17 by touching an OK button (3231). The display of the Address Book shown in FIG. 19 is sorted by the class in the name ascending order or name descending order by touching sort item setting buttons (3224 to 3226). An item selection count display region (3227) displays the number of items with selection marks.

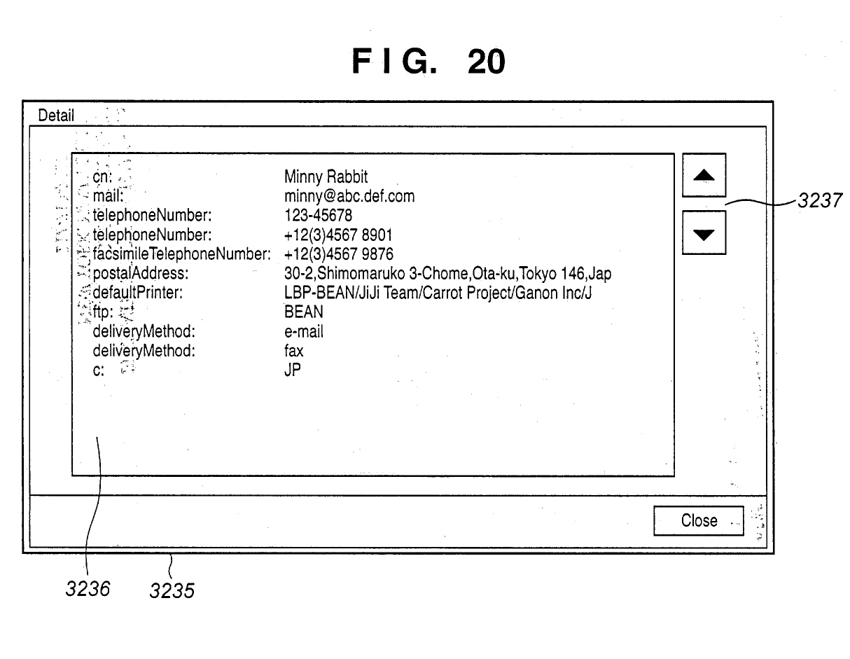

If the OK button (3231) or a cancel button (3230) is touched, the Address Book subwindow is closed, and the SEND main window is displayed. If a Detail button (3229) is touched while one item in the Address Book is selected, a Detail subwindow (3235) shown in FIG. 20 is displayed. The Detail subwindow displays all pieces of information obtained from the Address Book as pieces of information of selected items.

<Detailed Destination Subwindow>

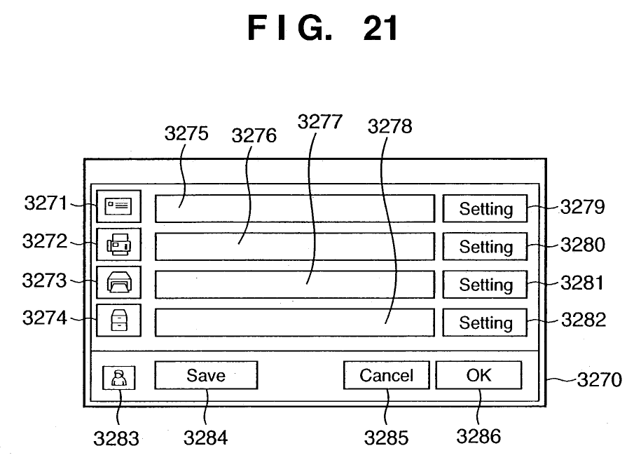

When the New button (3209) in the SEND main window shown in FIG. 17 is touched, a detailed destination window (3270) shown in FIG. 21 is displayed, and a new destination can be set. To input a destination, transmission method selection buttons (3271 to 3274) corresponding to transmission methods (E-mail, facsimile, printer, and FTP) are touched, or detailed destination input regions (3275 to 3278) are touched. For facsimile, a numeric keyboard is displayed; otherwise, a full keyboard is displayed, allowing an input. Reference numerals 3279 to 3282 denote buttons for performing transmission options of respective transmission methods, and a detailed description thereof will be omitted.

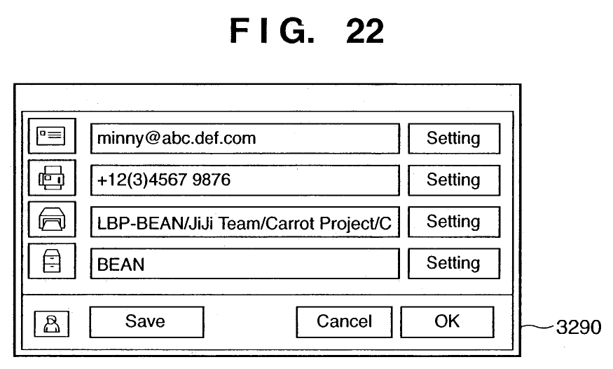

When the Edit button (3210) is touched while the destination of a Person class is selected in the SEND main window, a detailed Person class subwindow (3290) shown in FIG. 22 is displayed. Details of a selected destination are displayed in a corresponding one of the detailed destination input regions (3275 to 3278). A keyboard is displayed by the above-mentioned method, and the destination can be edited.

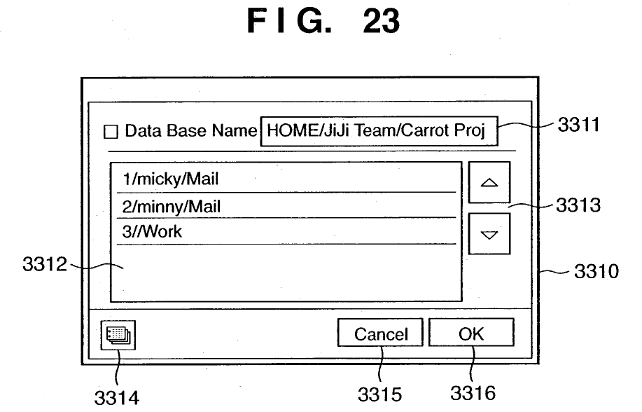

When the Edit button (3210) is touched while the destination of a Data Base class is selected in the SEND main window, a detailed Data Base class subwindow (3310) shown in FIG. 23 is displayed. The detailed Data Base class subwindow displays a Data Base name (3311) and folder list (3312).

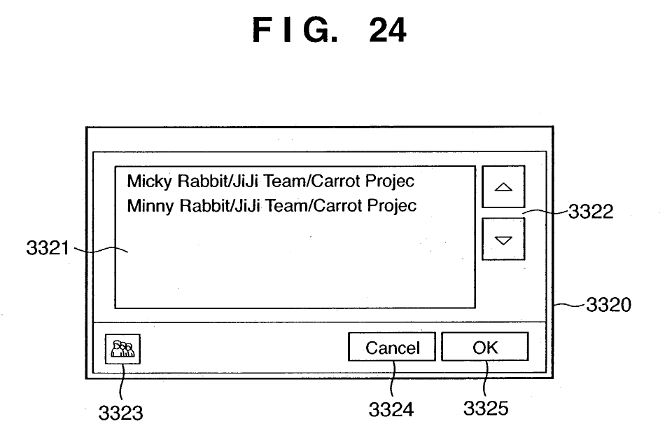

When the Edit button (3210) is touched while the destination of a Group class is selected in the SEND main window, a detailed Group class subwindow (3320) shown in FIG. 24 is displayed. The detailed Group class subwindow displays a Group member display (3321).

<HD SETTING Subwindow>

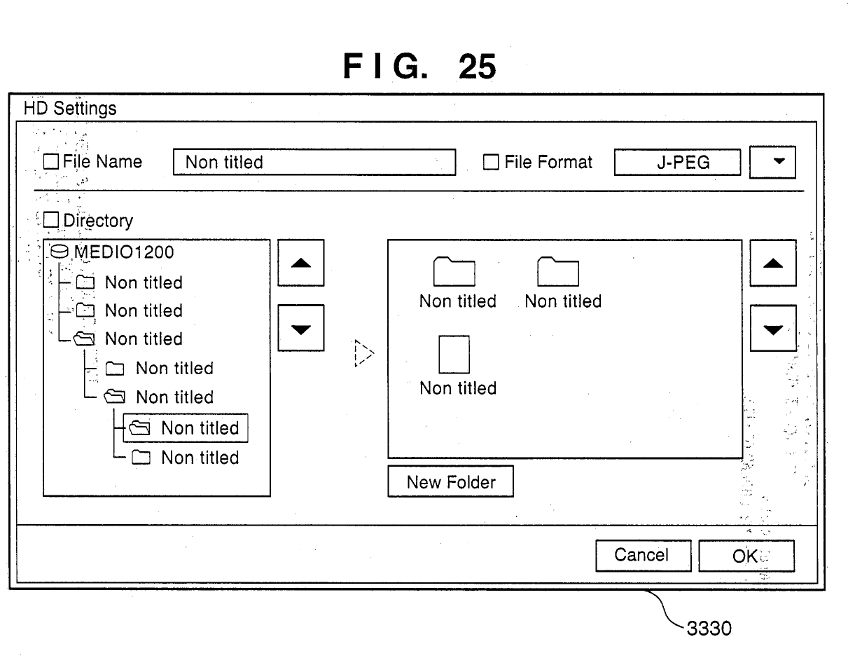

When the Put Into HD check button (3213) in the SEND main window shown in FIG. 17 is touched, an HD SETTING subwindow (3330) shown in FIG. 25 for setting for transmission to a hard disk is displayed. This subwindow is not directly related to the embodiment, and a detailed description thereof will be omitted.

<Print Out Subwindow>

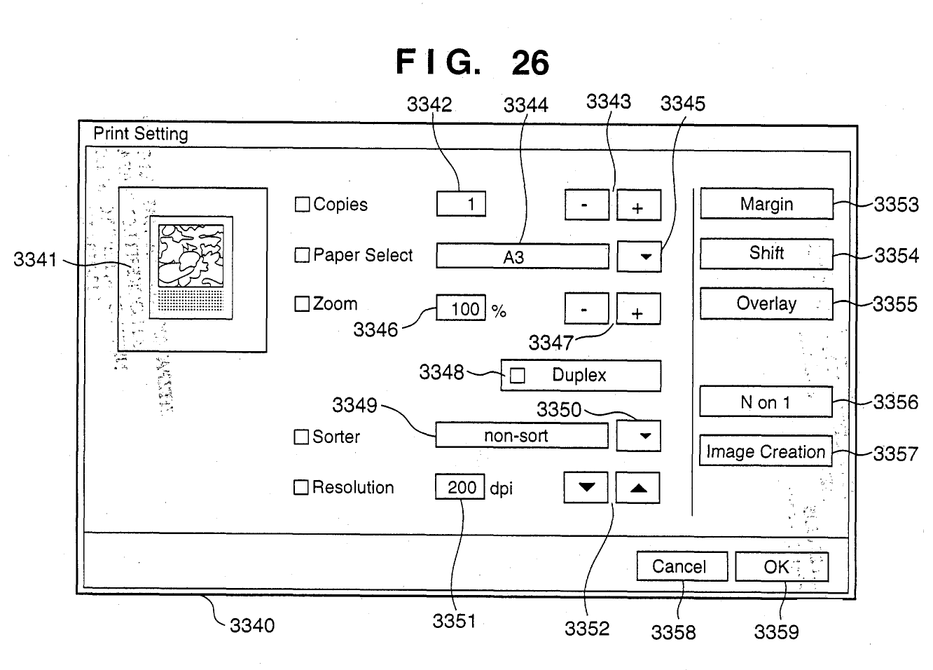

When the Print Out check button (3214) in the SEND main window shown in FIG. 17 is touched, a Print Out subwindow (3340) shown in FIG. 26 is displayed. The number of prints, paper size, enlargement/reduction ratio, 2-sided printing, sorting, resolution, and the like are set in the Print Out subwindow. When a paper size selection button (3345) is touched, a list of paper sizes is displayed, and a desired size is selected from the list. When a sorter selection button (3350) is touched, a list of selectable sorters is displayed.

<Scan Setting Subwindow>

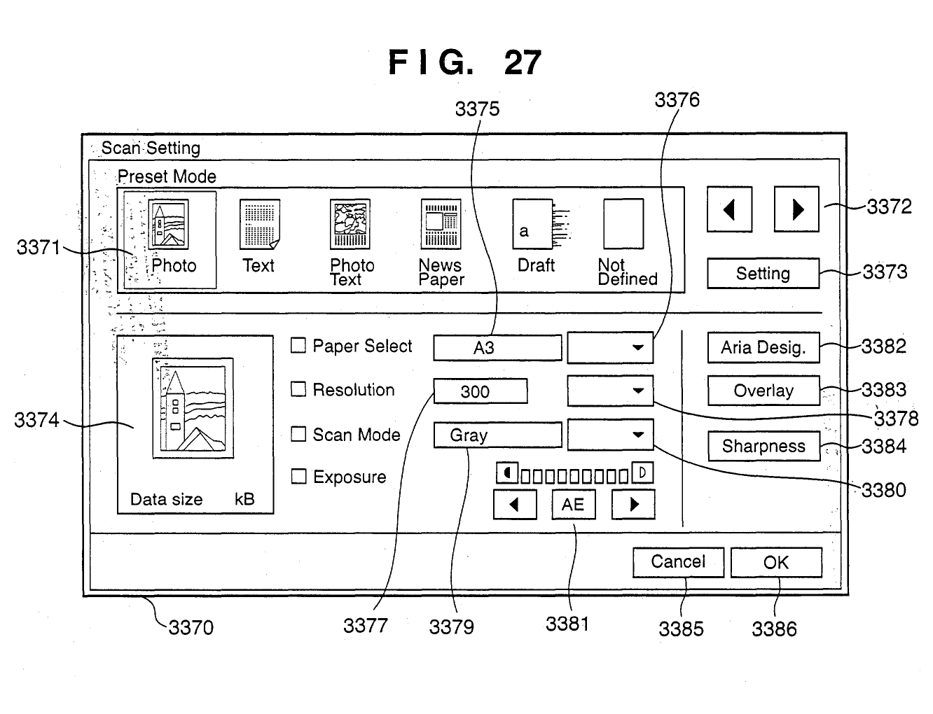

When the Scan Setting button (3215) in the SEND main window shown in FIG. 17 is touched, a Scan Setting subwindow (3370) shown in FIG. 27 is displayed. One scan setting is selected from a Preset mode selection region (3371) in the Scan Setting subwindow, and then a corresponding resolution, scan mode, and density set in advance are displayed in display regions (3377, 3379, and 3381). These values can also be manually changed.

<RETRIEVE Window>

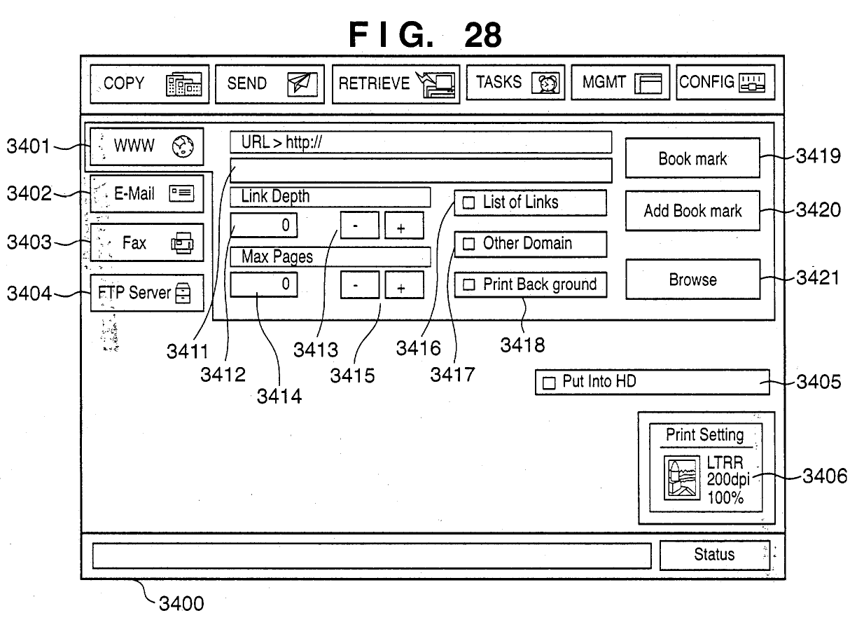

When the RETRIEVE tab (3013) is touched in the operation window (3010) shown in FIG. 15, a RETRIEVE main window (3400) shown in FIG. 28 is displayed. The RETRIEVE main window displays the subtabs of WWW (3401), E-mail (3402), Fax (3403), and FTP (3404), and a Put Into HD check button (3405) and Print Setting button (3406) commonly used for the subcategories. By touching the subtabs, corresponding WWW, E-mail, Fax, and FTP subwindows are displayed. In initialization including reset, the WWW subwindow is displayed.

<E-mail Subwindow>

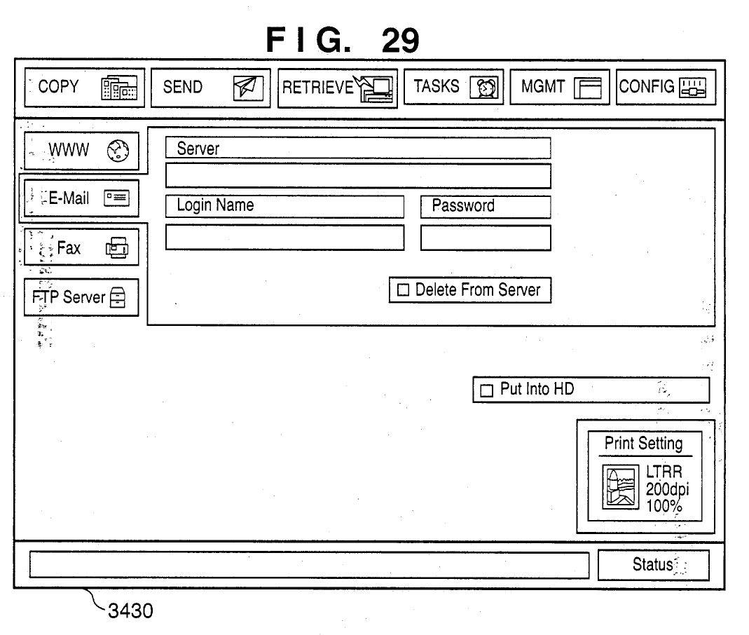

When the E-mail subtab (3402) shown in FIG. 28 is touched, an E-mail subwindow (3430) shown in FIG. 29 is displayed, and setting for receiving E-mail can be done. If each of input regions (3431 to 3433) is touched in this window, a full keyboard is displayed, allowing an input.

<Fax Subwindow>

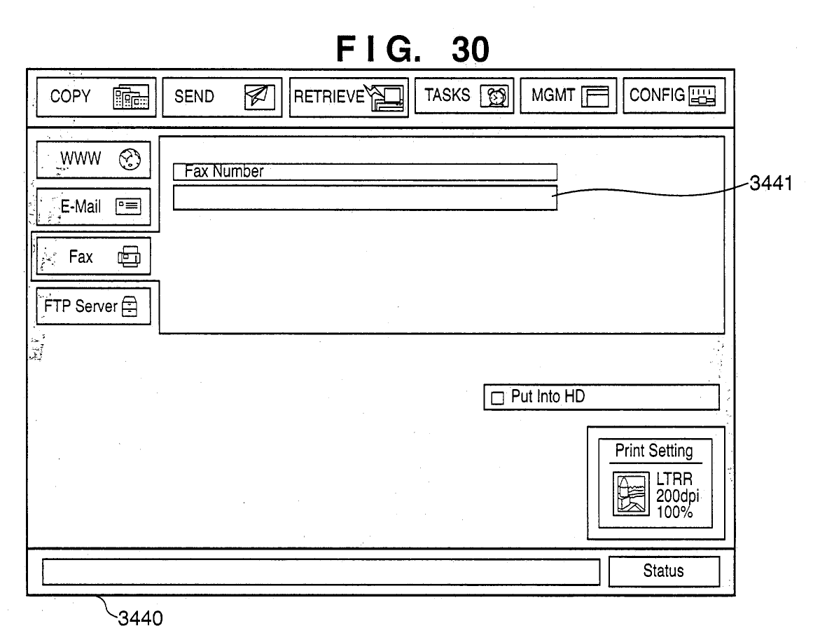

When the Fax subtab (3403) shown in FIG. 28 is touched, a Fax subwindow (3440) shown in FIG. 30 is displayed, and a Fax number can be input. If an input region (3441) is touched in this window, a numeric keyboard is displayed, and a Fax number can be input.

<FTP Server Subwindow>

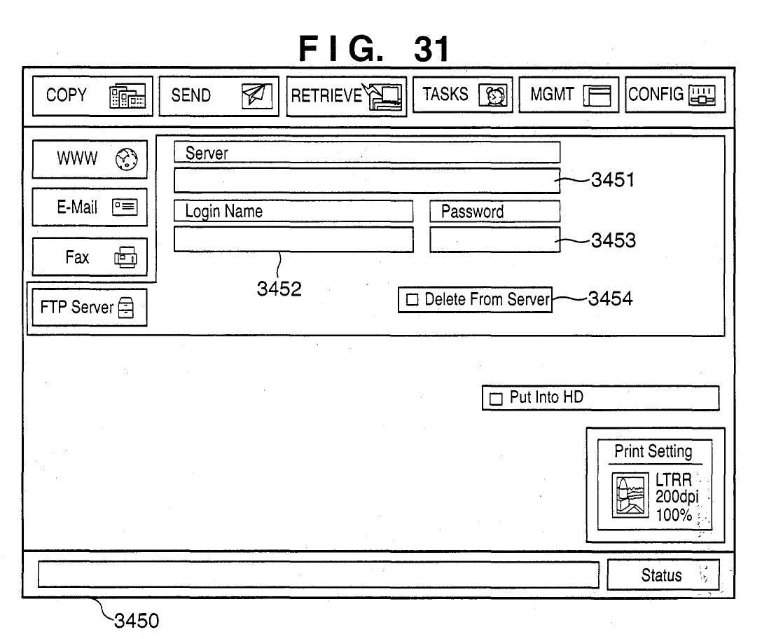

When the FTP subtab (3404) shown in FIG. 28 is touched, an FTP Server subwindow (3450) shown in FIG. 31 is displayed, and setting for receiving data from a server can be performed. If each of input regions (3451 to 3453) is touched in this window, a full keyboard is displayed, allowing an input.

<HD Setting Subwindow>

When the Put Into HD check button (3405) common to the categories in FIGS. 28 to 31 is touched, the HD Setting subwindow (3330) shown in FIG. 25 is displayed. The function is the same as that of the HD Setting subwindow in the Send main window.

<TASKS Window>

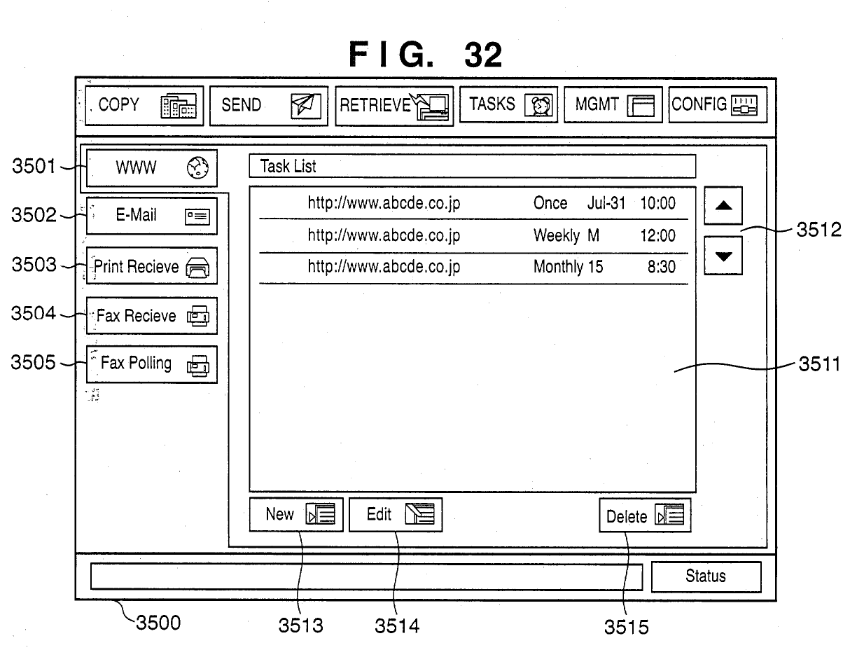

When the start key is touched while the TASKS window shown in FIG. 32 is displayed, automatic RETRIEVE operation is executed in accordance with parameters set in the TASKS window.

A TASKS main window (3500) displays WWW, E-mail, Print Receive, Fax Receive, and Fax Polling subtabs (3501 to 3505). In initialization including reset, the WWW subwindow (3501) is displayed.

<PDL Image Output Sequence>

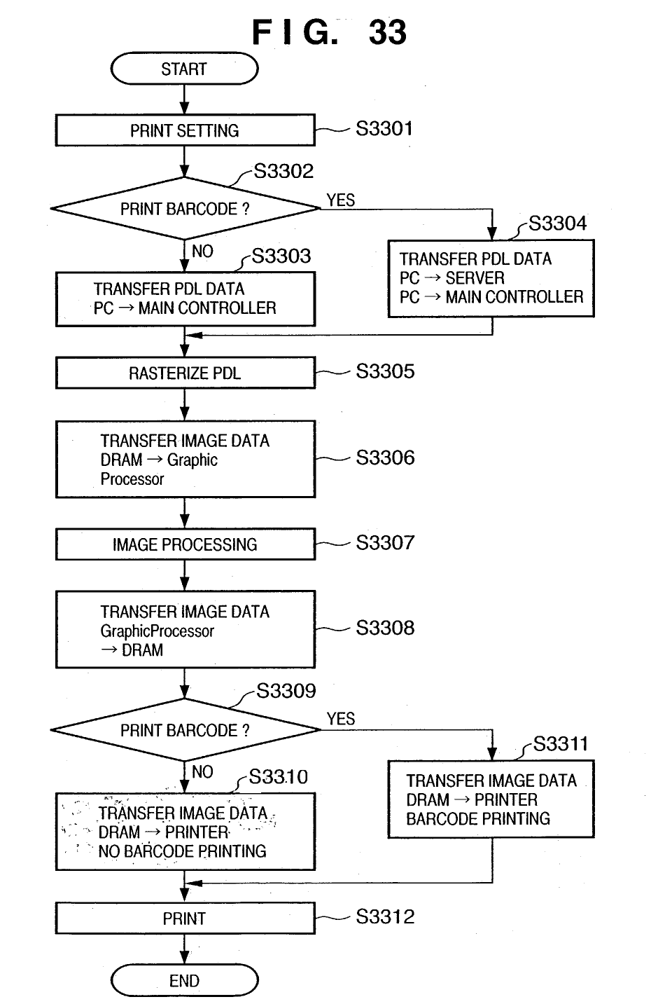

FIG. 33 is a flow chart showing PDL image output processing according to the embodiment. In FIG. 33, reference symbols S3301 to S3312 denote steps.

In outputting a PDL image, the user performs print setting of a PDL image output job in the PC 401 in S3301. Print setting contents are the number of copies, paper size, 1-sided/2-sided printing, page output order, sorting, stapling, and whether to store a PDL image in the server 403 and print a barcode as storage location information.

In S3302, whether the user has set barcode printing is determined. If NO in S3302, the flow advances to S3303, and driver software installed in the PC 401 converts code data to be printed in the PC 401 into so-called PDL data upon reception of a print instruction in the PC 401. The PDL data is transferred to the control apparatus 110 of the image input/output apparatus via the network 400 together with print setting parameters set in S3301.

If YES in S3302, the flow advances to S3304, and PDL data is transferred to the control apparatus 110 of the image input/output apparatus via the network 400, similar to S3303. At the same time, the PDL data is also transferred to the server 403, and the server 403 stores the PDL data as original image information at a predetermined address.

In S3305, the CPU 112 of the main controller 111 of the control apparatus 110 rasterizes the PDL data transferred via the connector 126 and network controller 125 into image data on the basis of the print setting parameters. Rasterization into image data is executed in the DRAM 122. Upon the completion of image data rasterization, the flow advances to S3306. In S3306, the main controller 111 transfers the image data rasterized in the DRAM 122 to the graphic processor 151.

In S3307, the graphic processor 151 performs image processing independently of the print setting parameters. For example, when the paper size designated by the print setting parameter is A4 but the sheet feed unit 360 of the printer section 300 has only A4R sheets, the graphic processor 151 rotates the image through 90°, outputting an image complying with an output sheet. Upon the completion of image processing of the image data, the flow advances to S3308, and the graphic processor 151 transfers the processed image data to the main controller 111. The main controller 111 stores the transferred image data in the DRAM 122.

In S3309, whether barcode printing has been set is determined. If NO in S3309, the flow advances to S3310, and the main controller 111 transfers the image data in the DRAM 122 to the printer section 300 at a proper timing while controlling the printer section 300 via the graphic processor 151, printer image processor 153, and connector 155. If YES in S3309, the flow advances to S3311, and the main controller 111 transfers the image data in the DRAM 122 to the printer section 300 at a proper timing while controlling the printer section 300 via the graphic processor 151, printer image processor 153, and connector 155. At this time, the printer image processor 153 adds to a predetermined position on a sheet a barcode representing address information of the server 403 where the original image is stored.

In S3312, the control apparatus 110 controls the printer section 300 to print out the image data. After the image data is printed out, i.e., the PDL job ends, PDL image output processing ends.

<Copy Image Output Sequence>

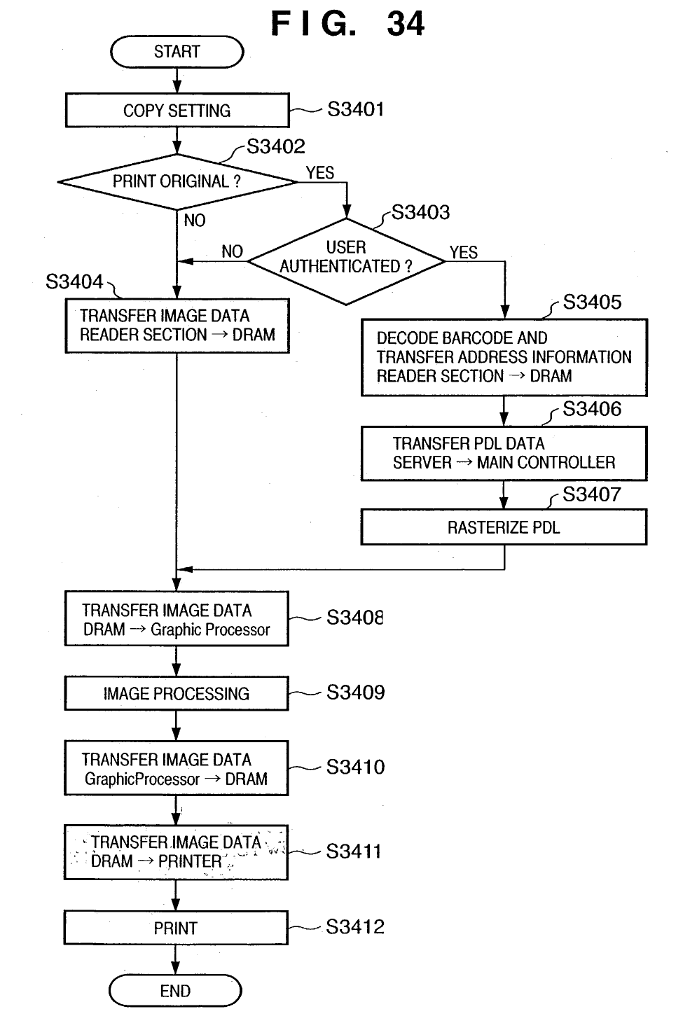

FIG. 34 is a flow chart showing copy image output processing according to the embodiment. In FIG. 34, reference symbols S3401 to S3412 denote steps.

In outputting a copy image, the user performs copy setting of a copy image output job from the operation section 180 in step S3401. Copy setting contents are the number of copies, paper size, 1-sided/2-sided printing, enlargement/reduction ratio, sorting, stapling, and whether to print an original image instead of standard copying.

In S3402, whether printing of an original image has been set is determined. If NO in S3402, the flow advances to S3404; if YES, to S3403 to display on the operation section 180 an authentication window for limiting the use of original printing by the user. The user inputs a user ID via the authentication window displayed on the operation section 180, and is authenticated.

In S3403, whether the user has been authenticated by the input user ID is determined. If NO in S3403, the flow advances to step S3404. Upon reception of a copy start instruction from the operation section 180, the main controller 111 of the control apparatus 110 controls the reader section 200 via the connector, and performs document image data loading operation. The document feed unit 250 feeds set document sheets one by one onto the platen glass 211, and at the same time detects the document size. The document sheet is exposed and scanned on the basis of the detected document size, reading image data. The read image data is compressed in an image format designated by the graphic processor 151, and stored in the DRAM 122. Thereafter, the flow advances to S3408.

If YES in S3403, the flow advances to S3405. Upon reception of a copy start instruction from the operation section 180, the main controller 111 of the control apparatus 110 controls the reader section 200 via the connector, and performs document image data loading operation. The scanner image processor 157 scans a barcode-printed region printed at a predetermined position on the document, and decodes the barcode into address information of the server 403 where the original image is stored. The address information is stored in the DRAM 122 via the graphic processor 151. In S3406, the main controller 111 searches for the original image stored in the server 403 via the network 400 on the basis of the address information stored in the DRAM 122. The server 403 transfers PDL data to the control apparatus 110 of the image input/output apparatus via the network 400. In S3407, the CPU 112 of the main controller 111 of the control apparatus 110 rasterizes the transferred PDL data into image data. Rasterization into image data is executed in the DRAM 122. Upon the completion of image data rasterization, the flow advances to S3408.

In S3408, the main controller 111 transfers the image data in the DRAM 122 to the graphic processor 151. In S3409, the graphic processor 151 performs image processing on the basis of copy setting parameters. For example, for 400% enlargement setting, zoom processing is executed in both the main scanning and subscanning directions using the image zooming unit serving as a module in the graphic processor 151. Upon the completion of image processing of the image data, the flow advances to S3410, and the graphic processor 151 transfers the processed image data to the main controller 111. In S3411, the main controller 111 transfers the image data in the DRAM 122 to the printer section 300 at a proper timing while controlling the printer section 300 via the graphic processor 151, printer image processor 153, and connector 155. In S3412, the control apparatus 110 controls the printer section 300 to print out the image data.

After all image data are transferred, i.e., the copy job ends, copy image output processing ends.

<Scanned-Image Transmission Sequence>

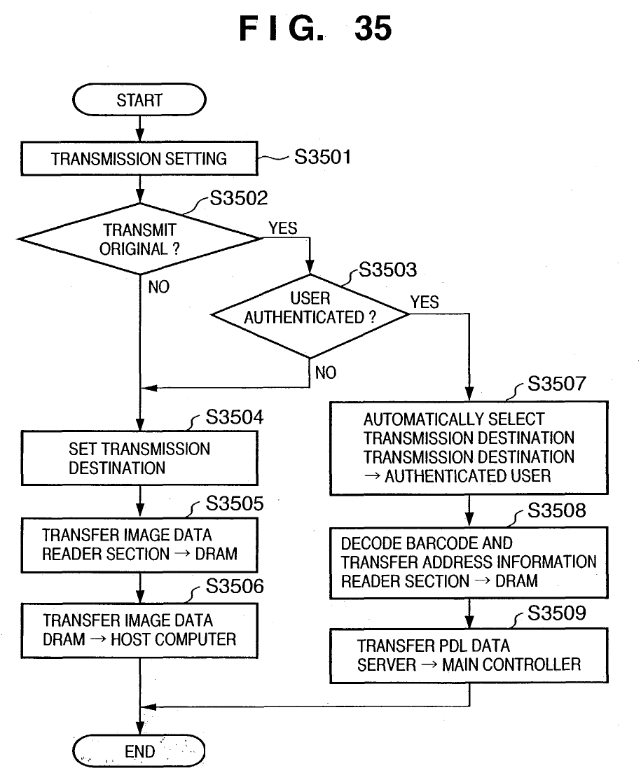

FIG. 35 is a flow chart showing scanned-image transmission processing according to the embodiment. In FIG. 35, reference symbols S3501 to S3509 denote steps.

In transmitting a scanned image via a network, in S3501, the user performs network transmission setting of a scanned-image transmission job based on the Send window shown in FIG. 17 on the operation section 180. Network transmission setting contents are monochrome/color data, document type, resolution, image compression ratio, and whether to transmit an original image instead of standard scan transmission.

In S3502, whether transmission of an original image has been set is determined. If NO in S3502, the flow advances to S3504; if YES, to S3503 to display on the operation section 180 an authentication window for limiting the use of original image transmission by the user. The user inputs a user ID via the authentication window displayed on the operation section 180, and is authenticated.

In S3503, whether the user has been authenticated by the input user ID is determined. If NO in S3503, the flow advances to step S3504 to perform setting of designating a scan transmission destination on the operation section 180. In S3505, upon reception of a scan start instruction from the operation section 180, the main controller 111 of the control apparatus 110 controls the reader section 200 via the connector, and performs document image data loading operation. The document feed unit 250 feeds set document sheets one by one onto the platen glass 211, and at the same time detects the document size. The document sheet is exposed and scanned on the basis of the detected document size, reading image data. The read image data is compressed in an image format designated by the graphic processor 151, and stored in the DRAM 122. In S3506, the image data stored in the DRAM 122 is transferred to the host computers 401 and 402 via the network 400.

After all image data are transferred, i.e., the scan transmission job ends, scan transmission ends.

If YES in S3503, the flow advances to S3507, and the control apparatus 110 automatically selects the address of the authenticated user as a transmission destination. In S3508, upon reception of a scan start instruction from the operation section 180, the main controller 111 of the control apparatus 110 controls the reader section 200 via the connector, and performs document image data loading operation. The scanner image processor 157 scans a barcode-printed region printed at a predetermined position on the document, and decodes the barcode into address information of the server 403 where the original image is stored. The address information is stored in the DRAM 122 via the graphic processor 151. In S3509, the main controller 111 searches for the original image stored in the server 403 via the network 400 on the basis of the address information stored in the DRAM 122. The server 403 transfers PDL data to the host computers 401 and 402 connected via the network 400.

After all image data are transferred, i.e., the scan transmission job ends, scan transmission processing ends.

In the embodiment, a barcode is used as image storage information, but the information is not limited to the barcode. The information may be information for specifying a server or a location where an original image is stored and may be information that the original image can be obtained. Furthermore, the server does not need to be located outside, and the original image may be stored within a multifunctional system.

The present invention may be applied to a system including a plurality of devices (e.g., a host computer, interface device, reader, and printer) or an apparatus (e.g., a copying apparatus or facsimile apparatus) formed from a single device.

The object of the present invention is also achieved when a storage medium which stores software program codes for realizing the functions of the above-described embodiment is supplied to a system or apparatus, and the computer (or the CPU or MPU) of the system or apparatus reads out and executes the program codes stored in the storage medium.

In this case, the program codes read out from the storage medium realize the functions of the above-described embodiment, and the storage medium which stores the program codes constitutes the present invention.

The storage medium for supplying the program codes includes a floppy® disk, hard disk, optical disk, magnetooptical disk, CD-ROM, CD-R, magnetic tape, nonvolatile memory card, and ROM.

The functions of the above-described embodiment are realized when the computer executes the readout program codes. Also, the functions of the above-described embodiment are realized when an OS (Operating System) or the like running on the computer performs part or all of actual processing on the basis of the instructions of the program codes.

The functions of the above-described embodiment are also realized when the program codes read out from the storage medium are written in the memory of a function expansion board inserted into the computer or the memory of a function expansion unit connected to the computer, and the CPU of the function expansion board or function expansion unit performs part or all of actual processing on the basis of the instructions of the program codes.

As described above, according to the embodiment, an original image can be searched for and output on the basis of information which represents a document original image storage location and is added to a document when the document is read and output for copying or transmission. The use of the function of searching for and outputting an original image can be limited by user authentication.

As many apparently widely different embodiments of the present invention can be made without departing from the spirit and scope thereof, it is to be understood that the invention is not limited to the specific embodiment's thereof except as defined in the appended claims.

What is claimed is:

1. An image processing apparatus which reads a document and outputs the document to a printing device or external device, comprising:
read means for reading an image on the document;
authentication means for authenticating whether a user can utilize an original image of the document when the image read by said read means contains image storage information representing a location where the original image of the document is stored;
search means for searching an image storage device which stores the original image of the document on the basis of the image storage information when the user is authenticated by said authentication means; and
output means for outputting the original image of the document formed by search by said search means to the printing device or external device.

2. The apparatus according to claim 1, wherein the image storage information includes information represented by a barcode.

3. The apparatus according to claim 1, wherein the image storage device includes a server device connected via a network.

4. The apparatus according to claim 1, wherein when the original image of the document is output to the external device via a network, said output means attaches the original image to E-mail, and outputs the E-mail with the original image.

5. The apparatus according to claim 1, further comprising means for causing the printing device to print the image storage information, and causing the image storage device to store the original image of the document.

6. The apparatus according to claim 1, wherein when the image read by said read means is output, said output means does not perform authentication by said authentication means.

7. A processing method for an image processing apparatus which reads a document and outputs the document to a printing device or external device, comprising:
a read step of reading an image on the document;
an authentication step of authenticating whether a user can utilize an original image of the document when the image read in the read step contains image storage information representing a location where the original image of the document is stored;
a search step of searching an image storage device which stores the original image of the document on the basis of the image storage information when the user is authenticated in the authentication step; and
an output step of outputting the original image of the document searched in the search step to the printing device or external device.

8. A program which causes a computer to function as each means of an image processing apparatus defined in claim 1.

9. A computer-readable recording medium which records a program defined in claim 8.
